(19) United States
(12) Patent Application Publication
(10) Pub. No.: US 2005/0086079 A1
(43) Pub. Date: Apr. 21, 2005

(54) Integrated and secure architecture for delivery of communications services in a hospital

(76) Inventors: Alan Frank Graves, Kanata (CA); Jeffrey Fitchett, Kanata (CA); Stephen Elliott, Allen, TX (US); Dany Sylvain, Gatineau (CA)

Correspondence Address: DOWELL & DOWELL P.C., Suite 309, 1215 Jefferson Davis Highway, Arlington, VA, 22202-3124, US

(21) Appl. No.: 10/813,230

(22) Filed: Mar. 31, 2004

Related U.S. Application Data
(60) Provisional application No. 60/503,965, filed on Sep. 19, 2003.
(60) Provisional application No. 60/505,941, filed on Sep. 25, 2003.

(51) Int. Cl. G06F 17/60

(52) U.S. Cl. 705/2; 705/3

(57) ABSTRACT

Service delivery architecture for delivering communications services within a hospital, comprising healthcare and non-healthcare data processing resources, a router and an access infrastructure leading from the router to a plurality of delivery points. The data routing entity controls access by the users at the plurality of delivery points to the healthcare and non-healthcare data processing resources. Healthcare and non-healthcare communications services are delivered over the same access infrastructure. For added security, the host comprises a plurality of authentication entities for authenticating users belonging to respective user classes. An access controller receives an authentication request message comprising user credentials and a user class regarding a user at an end user device. The access controller determines, based on the user class, a destination authentication entity and, releases the credentials towards the destination authentication entity.

### CROSS-REFERENCES TO RELATED APPLICATIONS

The present invention claims the benefit under 35 USC §119(e) of prior U.S. provisional patent application Ser. No. 60/503,965 to Graves, filed Sep. 19, 2003, incorporated by reference herein.

The present invention also claims the benefit under 35 USC §119(e) of prior U.S. provisional patent application Ser. No. 60/505,941 to Graves, filed Sep. 25, 2003, incorporated by reference herein.

The present invention is also related in subject matter to the co-pending U.S. patent application entitled “SYSTEMS AND METHODS FOR PRESERVING CONFIDENTIALITY OF HEALTHCARE INFORMATION IN A POINT-OF-CARE COMMUNICATIONS ENVIRONMENT” to Graves et al., filed on the same day as the present application and incorporated by reference herein in its entirety.

### FIELD OF THE INVENTION

The present invention relates generally to communications architectures and, in particular, to a secure, integrated architecture for the delivery of healthcare services to healthcare users at the point of care (POC) and non-healthcare services to non-healthcare users in a hospital.

### BACKGROUND OF THE INVENTION

The ability for healthcare users to interact with a hospital information system while at the point of care (POC), e.g., at a patient's bedside, is recognized as having the potential to dramatically reduce the incidence of certain medical complications. Specifically, studies estimate that significant benefits are likely to arise through the provision of “computerized physician order entry” (CPOE), which consists of allowing healthcare users (e.g., doctors, nurses, orderlies) to place orders (e.g., prescription, blood test, clean towel, etc.) via a bedside location in the vicinity of the patient being treated. This simple yet elusive paradigm, dubbed “CPOE at the POC”, has the potential effect of reducing human error due to temporary memory loss and mistakes in transcription. In addition, when coupled with real-time decision information support tools (DIST), CPOE provides healthcare users with an additional level of assurance that their diagnosis or treatment plan falls within generally accepted parameters.

For background reading on the CPOE-at-the-POC paradigm and its predicted impact, the reader is referred to the following references, hereby incorporated by reference herein:
Clinical Decision Support—Finding the Right Path, by J. Metzger, D. Stablein and F. Turisco, First Consulting Group, September 2002
Computerized Physician Order Entry: Costs, Benefits and Challenges—A case Study Approach, by First Consulting Group for Advancing Health in America and the Federation of American Hospitals, January 2003
Leapfrog Patient Safety Standards—The Potential Benefits of Universal Adoption, by J. D. Birkmeyer, The Leapfrog Group, November 2000
Computerized Physician Order Entry: A Look at the Vendor Marketplace and Getting Started, by J. Metzger, F. Turisco, First Consulting Group, December 2001
A Primer on Physician Order Entry, by First Consulting Group for the California Healthcare Foundation, Oakland, Calif., September 2000

A typical example of a conventional CPOE-at-the-POC solution consists of a plurality of CPOE terminals with associated clinical software residing on those terminals, and which can access, read and input directly into the Hospital Information System infrastructure. All required healthcare information is downloaded to the terminal and written to the hard drive for use by the applications that are resident in the terminal. The terminals have gated access via an authentication, authorization and accounting (AAA) solution, based upon centralized authentication of user identity and authorization of that user to specific sets of privileges. By virtue of the fact that all of the healthcare applications are resident in the terminal, the terminal is typically to be a powerful workstation or personal computer (PC).

It is a reality, however, that healthcare institutions have neither sufficient funds nor adequate physical space to deploy customized CPOE terminals based on powerful processors, and containing healthcare applications and healthcare data for each patient at that patient's bedside. Recognizing that television terminals delivering patient entertainment services are to be found in virtually every patient room, and that TV display technology and PC display technology and image processing are in many cases converging, it has been proposed to make healthcare applications such as CPOE accessible to healthcare users via the same terminal that supplies the patient entertainment services. Thus, terminals and software have been developed, which allow both healthcare communications services and non-healthcare communications services to be accessed via a common user interface, albeit with significantly different authentication metrics.

One approach to reducing the requirement to deploy separate CPOE terminals lies in mixing the healthcare and non-healthcare data delivery infrastructures at a common terminal. Some current systems which have adopted this approach provide healthcare applications (such as CPOE) for healthcare users, as well as health information, hospital information and entertainment/communication for non-healthcare users, via a common terminal and interface being fed by two underlying delivery infrastructures. Such attempts at merging healthcare and non-healthcare communications services use authenticated access via a separate so-called 10 bT or Cat 5 cabling infrastructure, as defined under TIA/EIA 568B, to the Hospital Information System while the TV display located in a patient room is provided with a “software TV tuner” or similar, as is commercially available, the tuner being fed by CATV sources from the CATV coaxial cable plant.

However, this approach merely provides commonality at the level of the display technology and human-machine interface (HMI), and still requires two separate infrastructures for delivery of both kinds of services, resulting in two sets of operating costs, two sets of failure points, etc. Moreover, it is often the case that existing 10 bT or Cat 5 cables in a hospital are not available a priori at the patients' bedsides, so often considerable extensions to cable runs will be required, leading to high cost and installation disruptions caused by the complexities of deploying new Cat 5 cables in a working hospital (e.g., closing of bed spaces while walls and ceilings were opened to install the required cables). Another problem with conventional approaches is the lack of security arising from the dual-purpose nature of the terminal. In particular, circumstances may arise in which a patient can either deliberately or accidentally enter credentials matching those of a healthcare user, thus allowing the patient unauthorized access to the healthcare infrastructure. This may arise from overlapping of authentication codes within the hospital authentication servers, or may result from an expert patient downloading specialized Trojan Horse or AAA-breaking software from the Internet to allow the recovery of a healthcare user's credentials.

Thus, there remains a need in the healthcare industry for providing true integrated access to healthcare communications services and non-healthcare communications services, while paying special attention to the security aspects regarding access to different applications by users belonging to different user classes (e.g., healthcare user and non-healthcare user).

### SUMMARY OF THE INVENTION

In accordance with a first broad aspect, the present invention seeks to provide an architecture for delivery of communications services within a hospital. The architecture comprises a set of healthcare data processing resources for providing healthcare communications services to users at a plurality of delivery points throughout the hospital and a set of non-healthcare data processing resources for providing non-healthcare communications services to the users at the plurality of delivery points. The architecture also comprises a data routing entity connected to the healthcare data processing resources and to the non-healthcare data processing resources and a common access infrastructure connected between the data routing entity and the plurality of delivery points, for supporting both the healthcare communications services and the non-healthcare communications services. The data routing entity is operative to control access by the users at the plurality of delivery points to the healthcare data processing resources and to the non-healthcare data processing resources.

In accordance with a second broad aspect, the present invention seeks to provide an access controller for use in authenticating users of a network. The access controller comprises an input operative to receive an authentication request message indicative of user credentials and a user class regarding a user of an end user device, a control entity operative to determine, based on the user class, a destination authentication entity from among a plurality of authentication entities and an output operative to release the user credentials towards the destination authentication entity for authentication of the user.

In accordance with a third broad aspect, the present invention seeks to provide a host processing entity for use in allowing users to access data processing resources in a hospital. The host processing entity comprises a plurality of authentication entities for authenticating users belonging to respective user classes and an access controller. The access controller is operative to receive an authentication request message comprising user credentials and a user class regarding a user at an end user device; determine, based on the user class, a destination authentication entity from among the plurality of authentication entities; and release the user credentials towards the destination authentication entity for authentication of the user.

In accordance with a fourth broad aspect, the present invention seeks to provide a method of controlling user access to resources in a data network. The method comprises receiving an authentication request message comprising user credentials and a user class regarding a user at an end user device; determining, based on the user class, a destination authentication entity from among a plurality of authentication entities; and releasing the user credentials towards the destination authentication entity for authentication of the user.

In accordance with a fifth broad aspect, the present invention seeks to provide computer-readable media tangibly embodying a program element for execution by a computing device to implement an access controller. The access controller comprises an interface entity operative to receive an authentication request message indicative of user credentials and a user class regarding a user at an end user device; a control entity operative to determine, based on the user class, a destination authentication entity from among a plurality of authentication entities; and the interface further operative to release the user credentials towards the destination authentication entity for authentication of the user.

In accordance with a sixth broad aspect, the present invention seeks to provide an access controller for controlling user access to resources in a data network. The access controller comprises means for receiving an authentication request message indicative of user credentials and a user class regarding a user at an end user device; means for determining, based on the user class, a destination authentication entity from among a plurality of authentication entities; and means for releasing the user credentials towards the destination authentication entity for authentication of the user.

In accordance with a sixth broad aspect, the present invention seeks to provide a method of formulating an authentication request message. The method comprises receiving authentication primitives from an end user, the authentication primitives being indicative of a user class and user credentials regarding a user; determining the user class from the authentication primitives; creating an authentication request message from the authentication primitives, the authentication request message containing data indicative of at least the user credentials and being in a format that is dependent upon the user class; and outputting the authentication request message.

In accordance with a seventh broad aspect, the present invention seeks to provide an end user device. The end user device comprises an input device operative to receive authentication primitives from an end user, the authentication primitives being indicative of a user class and user credentials regarding a user. The end user device also comprises a message formulator, operative to determine the user class from the authentication primitives and to create an authentication request message from the authentication primitives, the authentication request message containing data indicative of at least the user credentials and being in a format that is dependent upon the user class. Finally, the end user device comprises an output for releasing the authentication request message.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

FIG. 1 shows an integrated architecture for delivering healthcare communications services and non-healthcare communications services to a common delivery point at an end user device, including a detailed block diagram of a core hospital network;

FIG. 2 shows the integrated architecture of FIG. 1, including a detailed block diagram of the end user device;

FIGS. 3 and 4 show the integrated architecture of FIG. 1, including detailed a block diagram of two variants of a host processing entity;

FIGS. 5A-5D show authentication of a healthcare user and subsequent establishment of a connection for supporting a healthcare session;

FIGS. 6A-6D show authentication of a non-healthcare user and subsequent establishment of a connection for supporting a non-healthcare session;

FIGS. 7A-7E depict interruption of a non-healthcare session by receipt of a new authentication request message from the end user device;

FIG. 8 is a flowchart depicting operation of an access controller in the host, in accordance with an embodiment of the present invention;

FIG. 9 illustrates authentication primitives entered by a user for the purposes of authentication.

### DETAILED DESCRIPTION OF THE EMBODIMENTS

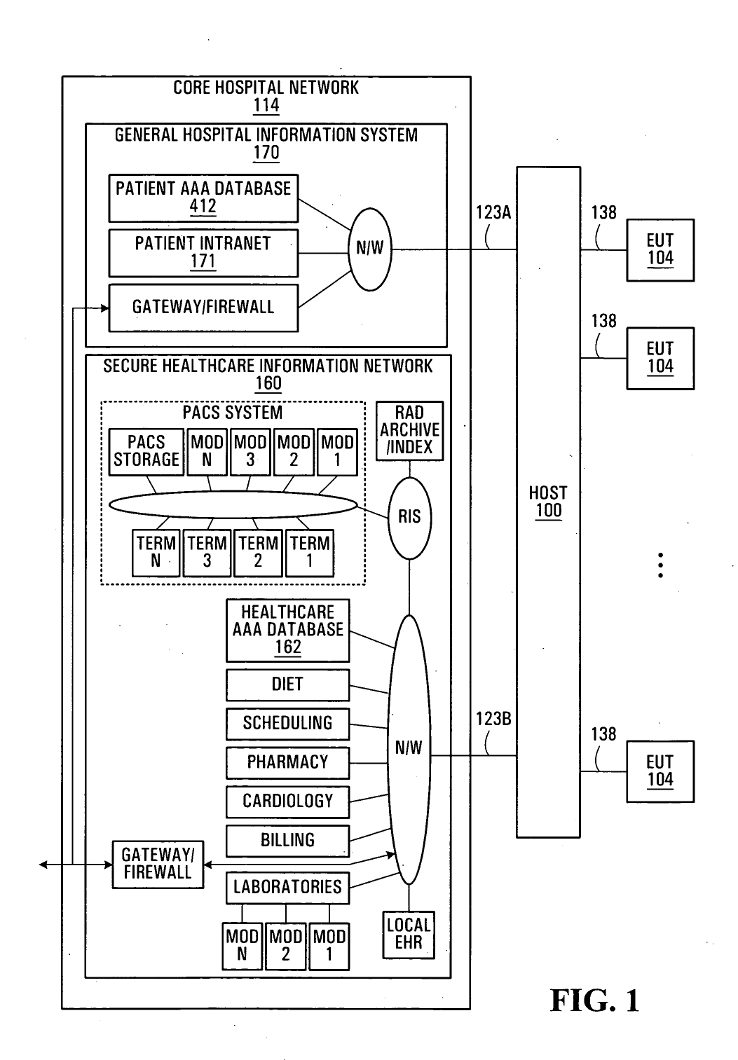

With general reference to FIGS. 1-4, there is shown an architecture for delivering healthcare communications services (e.g.; CPOE) to the point of care (POC) for healthcare users, while also delivering non-healthcare communications services (e.g., information, communications and entertainment) to non-healthcare users at their respective locations. This is hereinafter referred to as an integrated healthcare/non-healthcare data delivery architecture. The integrated healthcare/non-healthcare data delivery architecture comprises a host processing entity 100 (hereinafter “host”) and which consists of one or multiple instantiations, based on size, capacity, physical partitioning, and other factors, disposed between a core hospital network 114 and a plurality of end user devices 104.

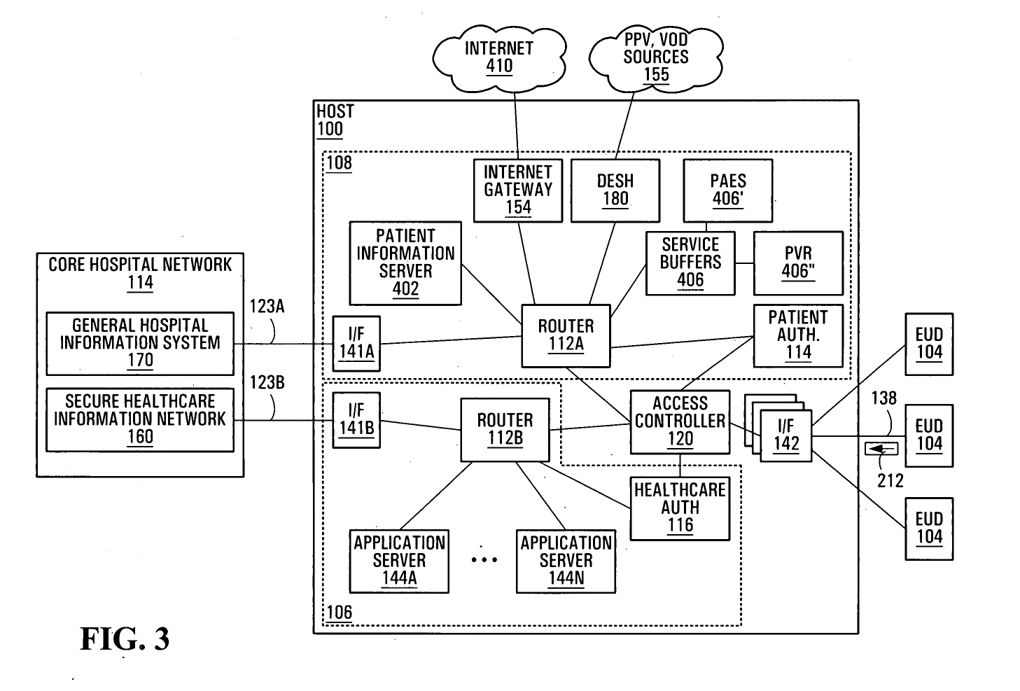

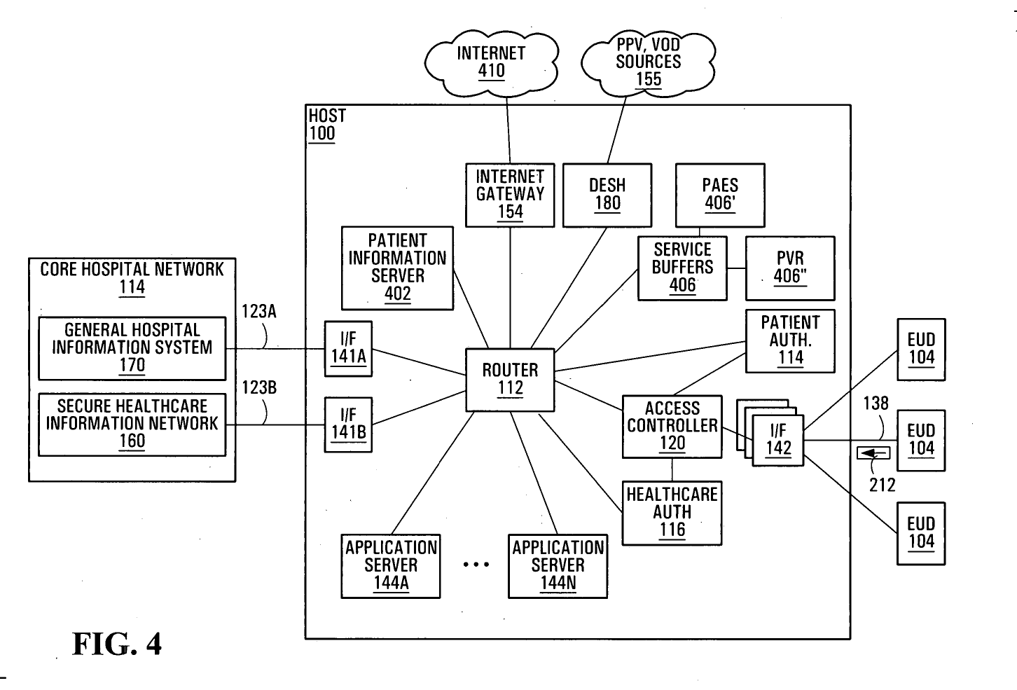

Two instantiations of host 100 are shown in FIGS. 3, 4 but it is understood that other partitionings and instantiations are equally possible.

Generally speaking, the basic functionality of the healthcare data delivery aspect of this integrated architecture is to provide authenticated healthcare users with real-time bidirectional access to a suite of clinical tools and databases which can assist their productivity and accuracy while interacting with the patient and making decisions about the patient's condition and treatment. It does this by providing access to a suite of clinical services and applications that may reside in the end user device 104, in the host 100 or in both locations, in order to access records of the patient, including historical records, results from recent/ongoing tests, previous/ongoing treatments and drug regimens, etc., while also allowing the healthcare user to capture his/her decision on patient condition, diagnosis, treatment orders and drug orders to the pharmacy, etc., in a direct entry process proven to reduce the incidence of clinical errors. Such a real-time approach allows the use of real-time Decision Information Support Tools (DIST) which can reside in the hospital core network 114 or which might reside as a service on a server in the host 100. Such tools provide validation of clinician orders, for instance by checking medical records for other drug prescriptions that are in effect which might lead to a drug interaction with the newly prescribed drug and cause an adverse drug reaction (ADR). The system achieves this required functionality by first properly authenticating the healthcare user to be who he/she claims to be, then admitting them on a limited basis to the host 100 and the core hospital network 114, based upon their access profile. The healthcare user can then access the necessary clinical tools residing on the end user device 104 or the host 100 to access healthcare data for those patients they are authorized to access to a level of read, read/write or write access as allocated from an AAA server located in the hospital core network 114.

On the other hand, the basic functionality of the non-healthcare data delivery aspect of this integrated architecture is to support a wide range of entertainment and information services for non-healthcare users. Examples of services that may need to be provided to the non-healthcare user, under various levels of authentication, include but are not limited to television, access to pay per view (PPV) and video on demand (VOD) movies, Internet access, intranet access for various hospital functions (such as patient education, dietary, etc.), electronic mail, and so on. These services are delivered using a common delivery infrastructure, specifically, one which is shared with the infrastructure used to deliver the healthcare services described above. The use of an integrated architecture can thus provide significant capital, installation and operating cost savings.

The end user device 104 is located at a common delivery point at the point of care (POC). An example of a point of care is a patient bedside or a ward. Another example of a point of care is an operating theater or an examination room. In the case where the end user device 104 is a wireless mobile device carried by a healthcare user, the POC will be governed by movement of the healthcare user, although in this case there may be less of a need to deliver non-healthcare communications services than in the case where non-healthcare users have access to the same terminals as healthcare users, which is generally, but not necessarily exclusively, in the bed wards of hospitals.

The host 100 communicates with the end user device 104 via a link 138, which will normally be fixed-wire cabling but may in some embodiments be a wholly or partly wireless link, or may be such a link in series with a virtual encrypted link over an interposed general purpose network. Suitable non-limiting examples of fixed-wire cabling for the link 138 include coaxial cable, as well as twisted pair (e.g., access-side PBX, Cat 2-3 or Cat 5). In another embodiment, the host 100 is connected via Ethernet connections (e.g., native Ethernet or Ethernet over DSL), to wireless base stations or access points to provide wireless LAN service in parts of the hospitals (such as examination rooms) where patient entertainment systems have not been installed.

In order to provide communication between the host processing entity 100 and the end user devices 104 in accordance with the integrated architecture of an embodiment of the invention, a common access infrastructure is used to provide both the healthcare communications services and the non-healthcare communications services. In an embodiment, the common cabling may use part of a pre-existing cabling infrastructure (e.g., point-to-point telephone cabling) for the purposes of implementing the links 138 to various end user devices 104. This is to avoid having to install a new wiring base, which could have disruptive impacts on the areas surrounding the installation, in that patients have to be removed from rooms where walls or ceiling or other “unclean” spaces are being opened. Of course, it is within the scope of the present invention to re-use other existing access infrastructures different from the telephone infrastructure in order to deliver the healthcare and non-healthcare communications services in an integrated fashion.

In addition to providing delivery of healthcare and non-healthcare communication services over a common access infrastructure, the architecture of the present invention may also simultaneously deliver basic analog or digital telephony. In this case, head end equipment provided at the host 100 would provide hybridizing functionality, and corresponding outstations would be installed remotely from the head end equipment, at some point further along the telephony plant. In this way, outstations are connected to telephone devices as well as to end user devices 104. For more information regarding the use of telephony cabling for delivery of telephony along with non-telephony communications services, the reader is referred to the above-mentioned U.S. provisional patent applications (Ser. No. 60/503,965 and Ser. No. 60/505,941), both incorporated by reference herein.

By way of example, a DSL-based access system can be used, with higher frequencies used to deliver the healthcare and non-healthcare communications services to the end user device 104 and the lower frequencies used to carry telephony signals. In cases where existing cabling lengths exceed the maximum reach of DSL (on the order of about 3000 ft), one or more closet-mounted DSL switch/aggregators may be encountered along the way. The need for switch-aggregators is much less likely to occur with DSL than would be the case with base 10 bT feeds due to the superior reach of DSL, and would only occur in the largest campus-based hospitals. However, recognizing the “mission-critical” nature of the healthcare services, the use of switch-aggregators may provide an additional margin to ensure sufficiently low probabilities of error, which are lower than those needed in a residential service delivery environment. Information about the design of suitable head end equipment and outstation equipment for delivery of data and telephony together in a hospital environment is contained in the above-mentioned provisional patent applications.

Each of the core hospital network 114, the end user device 104 and the host 100 will now be described in greater detail.

With specific reference to FIG. 1, the core hospital network comprises a general hospital information system (GHIS) 170 and a secure healthcare information network (SHIN) 160, which are connected to the host 100 via communication links 123A and 123B, respectively.

The secure healthcare information network 160 interconnects various hospital entities, such as radiology (connected to a PACS system), diet, scheduling, pharmacy, cardiology, billing, laboratories, local electronic health records, etc. The secure healthcare information network 160 also maintains a healthcare AAA database 162, which contains information allowing healthcare users to be authenticated. In an embodiment, the healthcare AAA database 162 comprises a collection of healthcare user identities and securely held corroborating evidence, along with an associated access profile for each healthcare user, which will include a dynamic patient access list based on the hospital's admissions database together with a specific mapping of who has what accessible data, based upon professional qualifications, status and allocation to patient treatment teams, which itself may be dynamic, especially for shift workers such as nurses. The secure healthcare information network 160 further interconnects to the general hospital information system 170 via a firewall.

For its part, the general hospital information system 170 allows access to a patient intranet 171 and maintains a non-healthcare AAA database 412. In an embodiment, the non-healthcare AAA database 412 comprises a collection of non-healthcare user identities and securely held corroborating evidence, along with an associated access profile for each non-healthcare user. Both the healthcare AAA database 162 and the non-healthcare AAA database 412 are managed by a hospital admissions server (not shown).

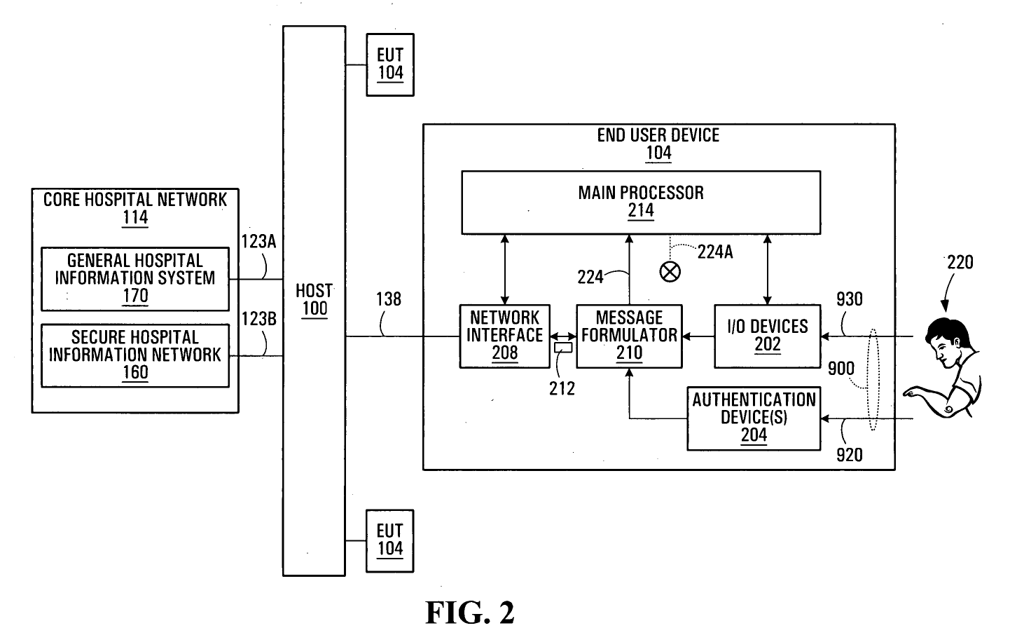

With reference now to FIG. 2, the end user device 104, which is accessed by a given user 220, comprises a network interface 208 to the host 100, a main processor 214, a message formulator 210, a set of I/O devices 202 and one or more authentication devices 204.

The main processor 214 exchanges data with the host 100 via the network interface 208. In the downstream direction, data received from the host 100 at the main processor 214 may include host-generated data destined for the user 220, which is processed by the main processor 214 and provided to the user 220 via the I/O devices 202. In the upstream direction, data sent to the host 100 from the main processor 214 may include data entered by the user 220 via the I/O devices 202 and processed by the main processor 214.

In one embodiment, the main processor 214 is equipped with a hard drive for storing an operating system, I/O drivers and software for start-up, human-machine interface (HMI), display formatting and data collection. The end user device 104 can be a PC-based workstation with the hard drive being used to store healthcare application software, along with accompanying healthcare data for the patient in question. In such an embodiment, there may be some security risks due to storage of healthcare information on the hard drive, which of course retains storage when the unit is de-powered, and allows that healthcare information to be revealed if stolen or probed. This security risk can be reduced by appealing to techniques for preserving the confidentiality of healthcare information stored in end user device. For examples of such techniques, the reader is referred to the co-pending U.S. patent application entitled “SYSTEMS AND METHODS FOR PRESERVING CONFIDENTIALITY OF HEALTHCARE INFORMATION IN A POINT-OF-CARE COMMUNICATIONS ENVIRONMENT” to Graves et al., filed on the same day as the present application and incorporated by reference herein in its entirety.

The main processor 214 manages the processing load presented by the operating system, local applications, as well as residual functions in the end user device 104 which are primarily associated with data collection, formatting and display. Interaction with the user via the I/O devices 202 may involve implementation of a web browser for receiving user input, displaying still images and interacting with the user via input boxes for applications which have been centralized in the host 100. This may also involve implementation of an MPEG decoder or media player for display of video images, a voice codec for audio input/output.

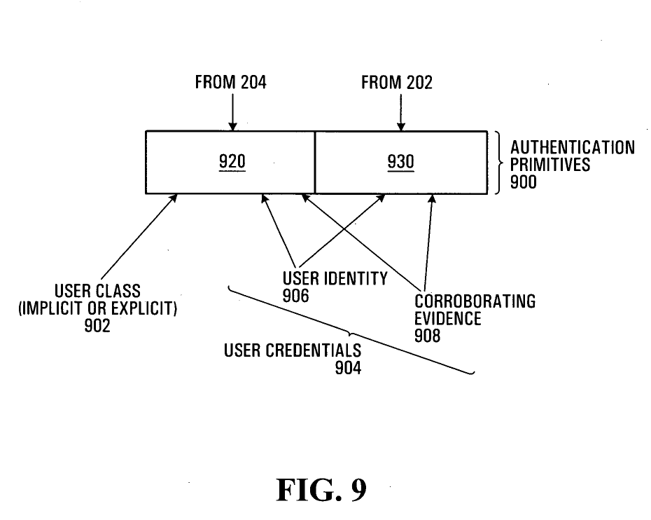

With additional reference to FIGS. 2 and 9, the authentication device(s) 204 receive a first portion 920 of a set of authentication primitives 900 input by the user 220. Examples of an authentication device 204 include but are not limited to one or more of a magnetic card reader, a bar code scanner (e.g., for reading a user's bracelet), a biometric (e.g., fingerprint scanner, iris scanner,), etc. Of course, other methods of achieving authentication primitives may be devised and are within the scope of the invention.

In addition, a second portion 930 of the authentication primitives 900 is entered by the user 200 via the I/O devices 202. Examples of suitable I/O devices 202 include but are not limited to a keyboard/mouse arrangement with a display having a built-in touch screen.

The message formulator 210, which will be described in greater detail later on, is responsible for formulating an authentication request message 212 based on both portions 920, 930 of the authentication primitives 900 input by the user 220 via the authentication device(s) 204 and the I/O devices 202. The message formulator 210 is operable to send the authentication request message 212 so generated to the host 100 via the network interface 208.

It is noted that different combinations of the authentication device(s) 204 and the I/O devices 202 can be used in order to supply the authentication primitives 900. This allows healthcare users and non-healthcare users to enter entirely different data. By way of a specific example, healthcare users may swipe magnetic cards into a magnetic card reader and enter alphanumeric PINs via a keyboard, while non-healthcare users may simply enter user names and passwords via the keyboard. Thus, it can be said that part of the authentication primitives 900 contain a “user class” 902, either explicitly (as one or more bits in the first portion 920), or implicitly (e.g., as a checksum or numerical range), which is different for users in what can be termed different “user classes”.

The existence of this difference helps reduce the risk of inadvertent mis-identification should the two AAA databases 162, 412 not use coordinated identifiers. Coordinated identifiers are usually not required if the two AAA databases control access to two disconnected systems with orthogonal functionality, as is the case with conventional delivery of healthcare and non-healthcare communication services. However, when both types of communication services are delivered via a common, integrated architecture as is the case here, and if the two AAA databases continue to not use coordinated identifiers, additional precautions are taken to ensure separation of functionality and users. Specifically, different user classes are associated with the performance of authentication procedures by separate authentication entities in the host. The two main examples of “user class” as used herein include a healthcare user class, and a non-healthcare user class (which can include bona fide admitted patients and their registered or unregistered visitors). However, it should be understood that the healthcare user class may further be broken down into sub-classes such as clinicians (physicians, nurses, technicians) and non-clinicians (orderlies, contractors). In fact, the definition of classes is dictated only by operational requirements and thus may lead to different definitions for different practical applications.

It is desirable to employ a technique which prevents tampering with the user class, specifically, whereby the user 220 cannot enter authentication primitives identifying himself or herself as belonging to a given user class unless the user 220 actually does belong to that user class. In one suitable embodiment, the user 220 has the responsibility of carrying a uniquely personalized device on his or her person (e.g., a bar-coded badge, magnetic card, or RF-ID enabled element such as a badge) which encodes data in a way so as to indicate that the bearer belongs to a particular user class (e.g., non-healthcare or healthcare user). For example, the user class may be encoded as a field in the bar code of a bracelet or badge. The user class can thus be determined immediately upon the user 220 entering his or her magnetic card or bar coded badge to the authentication device 204 (suitably implemented as a bar code reader or a magnetic card reader).

In addition to the user class 902 described above, the authentication primitives 900 contain “user credentials” 904 that are distributed between the first portion 920 and the second portion 930 of the authentication primitives 900 and which serve to the identify the individual user 220. It is desirable to employ a technique which allows the user 220 to identify himself or herself, but prevents the user 220 from entering the user credentials of another user in that same user class. Thus, in a suitable embodiment, the user credentials 904 may include a private (but not necessarily confidential) portion that provides an indication of who the user claims to be (hereinafter referred to as a “user identity” 906, akin to a login name), as well as a confidential portion indicative of proof that the user is who he or she claims to be (hereinafter referred to as “corroborating evidence” 908, akin to a password). In combination, the user identity 906 and the corroborating evidence 908 form unique user credentials 904 for each user amongst all user classes. In other words, the user credentials 904 of each non-healthcare user are different from the user credentials of each of the other potential non-healthcare users and from the user credentials of each of the potential healthcare users.

In one non-limiting embodiment, the user identity 906 forms part of the first portion 920 of the authentication primitives 900 and is entered via the authentication device(s) 204 (e.g., data entered by way of a magnetic card, bar coded badge or RF-ID enabled element). The corroborating evidence 908 forms part of the second portion 930 and is entered via the I/O devices 202 (e.g., a code, such as a PIN or password, entered via a keyboard or mouse).

In another non-limiting embodiment, the user identity 906 forms part of the second portion 930 of the authentication primitives 900 and is entered via the I/O devices 202 (e.g., a user name or user ID entered via a keyboard or mouse). The corroborating evidence 908 forms part of the first portion 920 and is entered via the authentication device(s) 204 (e.g., a finger supplied to a fingerprint scanner).

To ensure that non-healthcare users who try to “crack” the non-healthcare database 412 in order to get free services are prevented from “cracking” the healthcare database 162, the user identity and corroborating evidence corresponding to the various potential healthcare users and non-healthcare users should be designed so as to prevent the same user credentials from identifying the different users. For example, design considerations should be taken into account so as to prevent the scenario in which the user credentials 904 for a senior clinician in the healthcare database 162 are XYZ (by virtue of the user identity 906 via bar code scan being X and corroborating evidence 908 via PIN being YZ), will be the same as the user credentials 904 for a-non-healthcare user in the non-healthcare AAA database 412 (by virtue of the user identity 906 via magnetic card reader being XY and corroborating evidence 908 via PIN being Z). To achieve this, an authentication request message generated on the basis of authentication primitives entered by a non-healthcare user might include a patient's name and a bar code scan (BCS) in a certain range, whereas an authentication request message generated on the basis of authentication primitives entered by a healthcare user might include a bar code scan in a different range plus a multi-digit PIN.

The message formulator 210 performs a high-level validation to determine whether the authentication primitives 900 comply with an expected data format for a particular user class, without actually performing authentication of the user (since that would require the downloading of authentication database content into uncontrolled environment of the end user device 104 or giving that device direct access to the healthcare AAA database 162 as well as the non-healthcare AAA database 412). Upon successful high-level validation, the authentication request message formulator 210 creates the authentication request message 212, which will contain the entered authentication primitives 900 and additional data (e.g., in the form of a marker, address or formatting difference) which encodes the user class, allowing the access controller 120 in the host 100 to correctly onwardly route the authentication request message 212 to one of the authentication entities 116, 114. It is noted that the formulation of authentication request message 212 is isolated from the main processor 214 and so cannot be tampered with by software downloaded into that processor.

The authentication request message 212 is sent towards the network interface 208 for upstream transmission towards the host 100 via link 138. The message formulator 210 is also adapted to respond to successful or unsuccessful authentication of the user 220, as determined from downstream messages received from the host 100. In one embodiment, in response successful authentication, the message formulator 210 sends an enabling command to the main processor 214, while in the case of an unsuccessful authentication, the message formulator 210 sends a disabling command to the main processor 214, which allows control of the user access to the message formulator 210 or other resources in the end user device 104. It is noted that the enabling link to the main processor 214 is, from the message formulator perspective, a “write only” line with no reverse read capability from the main processor 214. This is illustrated by the broken link 224A in FIG. 2.

In addition, the message formulator 210 is operable to process data received from the host 100, which may include messages indicative of successful or unsuccessful authentication, as well as message formatting parameters. The message formulator 210 may be implemented as a dedicated hardware component, a hardware state machine or a software processing engine. It may be integrated with the main processor 214, or it may be separated, isolated or protected from the main processor 214.

With reference to FIG. 3, there is shown a first variant of the host 100, in which healthcare and non-healthcare communications services are generated independently and merged at the point of delivery over a common cabling infrastructure throughout the hospital. This first variant of the host 100 comprises an interface (I/F) 142, an access controller (AC) 120, healthcare data processing resources 106 and non-healthcare data processing resources 108.

The healthcare data processing resources 106 comprise a routing entity (router) 112B to which are connected a healthcare authentication entity (HA) 116, a plurality of application servers (AS) 144A, . . . , 144N and an interface (I/F) 141B. The interface 141B connects to the secure healthcare information network 160 via link 123B. The access controller 120 has direct links to the routing entity 112B as well as to the healthcare authentication entity 116.

The application servers 144A, . . . , 144N are responsible for running and executing healthcare applications (such as a CPOE service, decision information support tools, prescription drug order entry service, radiology image viewing service, etc.) and storing temporary medical data (volatile or otherwise). One or more of the application servers 144A, . . . , 144N may also be responsible for data gathering from the core hospital network 114, which is achieved by communicating with a department in the secure healthcare information network 170 via the routing entity 112B and the interface 141B. This may require access to the secure healthcare information network 160 and therefore the particular healthcare application may comprise a data mining sub-function which places data requests to the secure healthcare information network 160 and receives the requested data in return. The healthcare application servers 144A, . . . , 144N are operative to open a healthcare “session” once the user has been successfully authenticated, at which point the healthcare application servers 144A, . . . , 144N begin configuring data for the end user device 104, including display characteristics, screen presentation, graphics, active information, input boxes, etc. For example, a page formatter can provide data for the end user device 104 in pages that are pre-formatted for display.

In a small hospital the application servers 144A, . . . , 144N might be implemented on a single computing device, whilst in a larger hospital deployment, with perhaps hundreds of terminals, a single computer-based server would be inadequate. Hence, the application servers 144A, . . . , 144N evolve into an application server complex with various specialized servers interconnected by a router or switch and with one server providing the master sequencing and data display formatting. The use of a server complex has several advantages. Firstly, multiple application servers can provide some form of protection against failure so that, in the event of a server failure, the system slows down but does not fail, with other servers picking up the traffic load of the failed, server. Also, a centralized suite of servers makes application software upgrades much smoother and easier, especially relative to trying to upgrade such software if it were resident in mobile devices, some of which are guaranteed not to be on-site at the time of upgrade, in addition to the sheer number of machines to upgrade. Additionally, an individual server can be taken out of service for an upgrade or for application suite upgrade without taking the system down, and that upgrade can be exhaustively checked before returning the server to the system.

The non-healthcare data processing resources 108 comprise a routing entity (router) 112A to which are connected a non-healthcare authentication entity (PA) 114, service buffers (SB) 406 which contain (i) video services buffering functionality (including, e.g., personal video recorders (PVRs 406″) for allowing non-healthcare users to record movies and play them back at a later time, in the event the non-healthcare session needs to be interrupted) as well as (ii) processing service buffers (i.e., the Patient Application Execution Server (PAES) 406′) where computer applications such as Internet downloads, games, etc. are run in a secure firewalled environment, a digital entertainment service head end (DESH) 180, a patient information server (PIS) 402, which provides access to a patient-accessible information suite—for instance hospital services, billing, dietary selections, etc., an Internet gateway (IGW) 154 and an interface (I/F) 141A. The interface 141A connects to the general hospital information system 170 via link 123A. The access controller 120 has direct links to the routing entity 112A as well as to the non-healthcare authentication entity 114.

Various services can be delivered as packetized switched digital signals from the digital entertainment services head end 180. For example, the digital entertainment services head end 180 generates digitized streaming video feeds from input analog CATV channels by a process of digitization or directly receives digitized CATV feeds from the service provider. The digital entertainment services head end 180 may also provide streaming video feeds for pay-per-view (PPV) channels or video-on-demand (VOD) channels, either generated locally or provided from a PPV or VOD source 155 (e.g., a service provider in-feed). Each non-healthcare user is in effect a subscriber into this system, having pre-purchased (or spot-purchased) a specific authentication and authorization level, and the non-healthcare authentication entity 114, upon receiving a request from the non-healthcare user, validates that request and then authorizes the release of the requested program material from the digital entertainment services head end 180. The digital entertainment services head end 180 then delivers a flow of streaming video as a stream of IP-based packets, through to the end user device 104, where they are converted, via a media player or an MPEG decoder, into sound and video for presentation to the non-healthcare user.

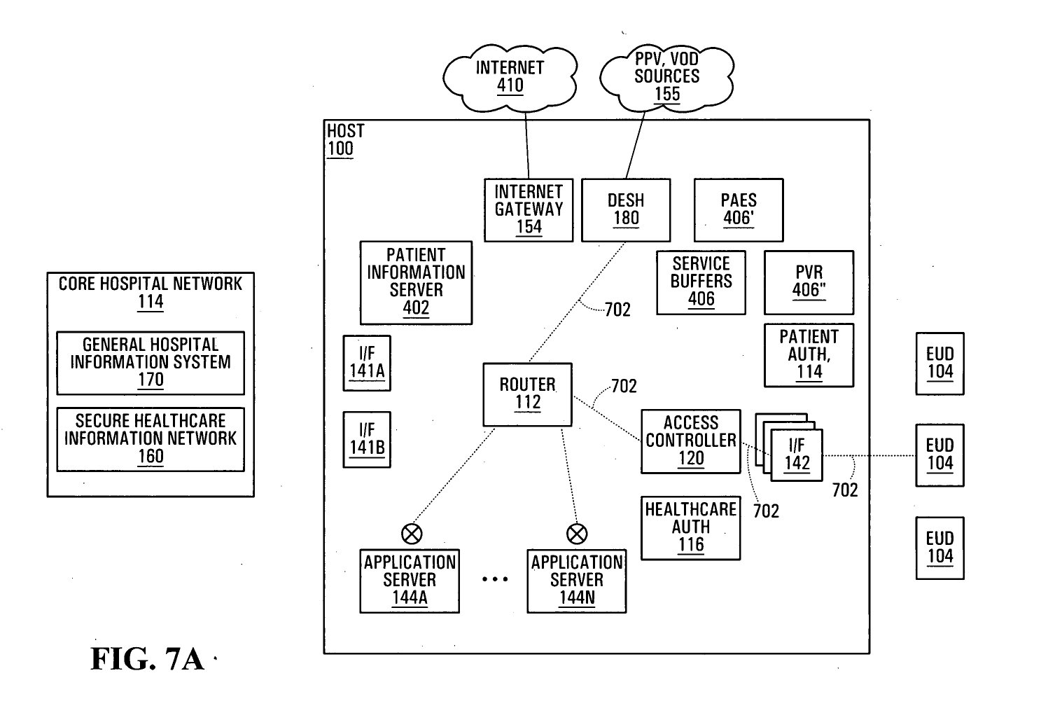

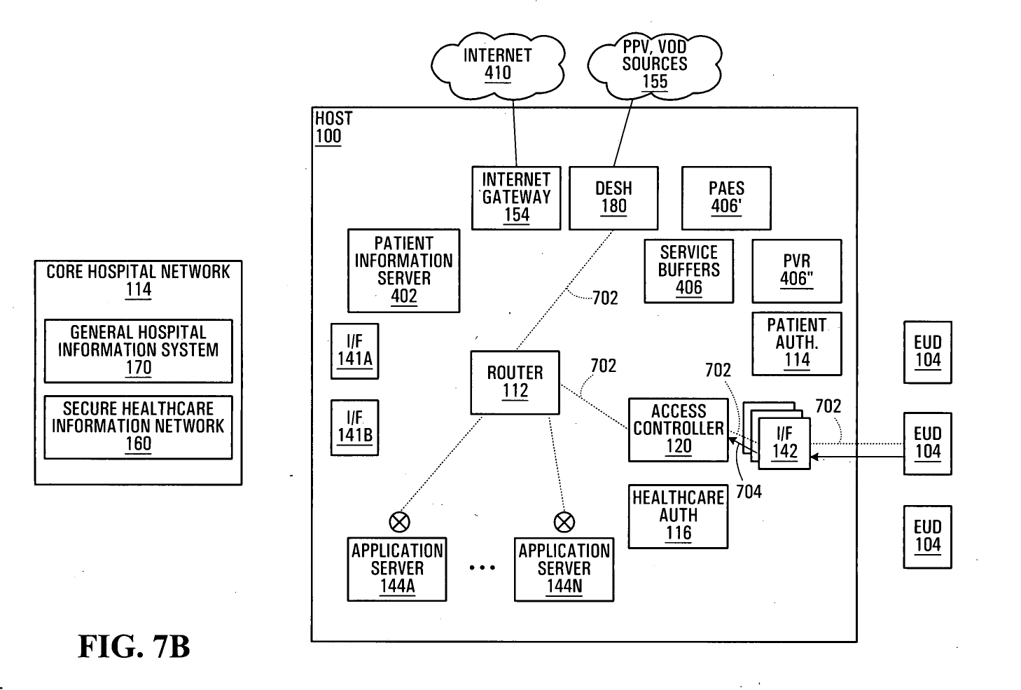

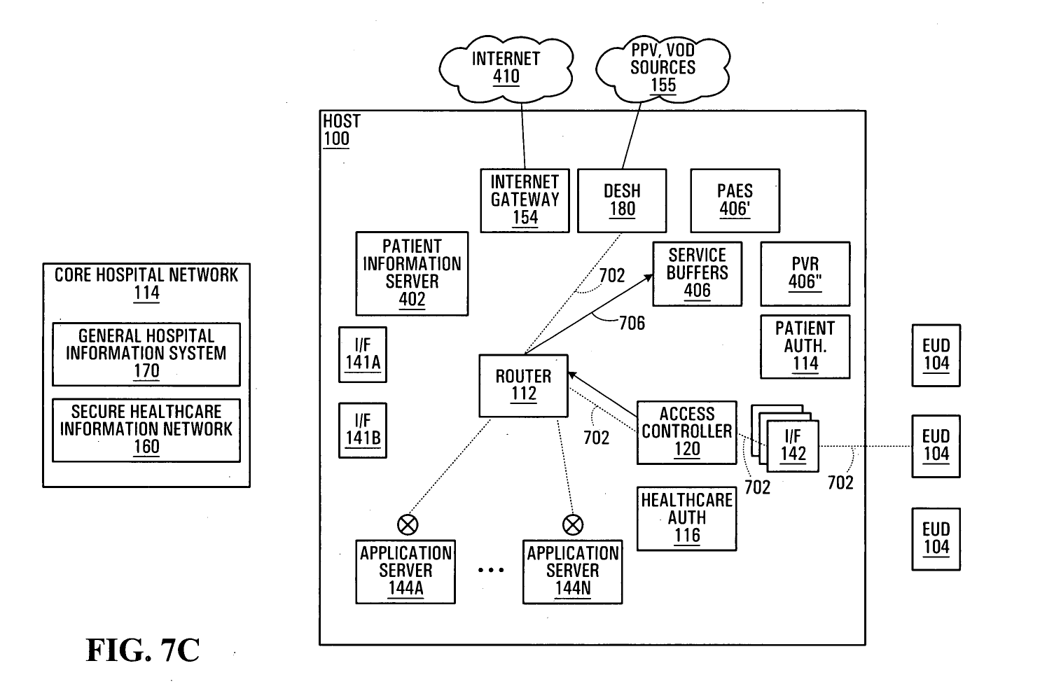

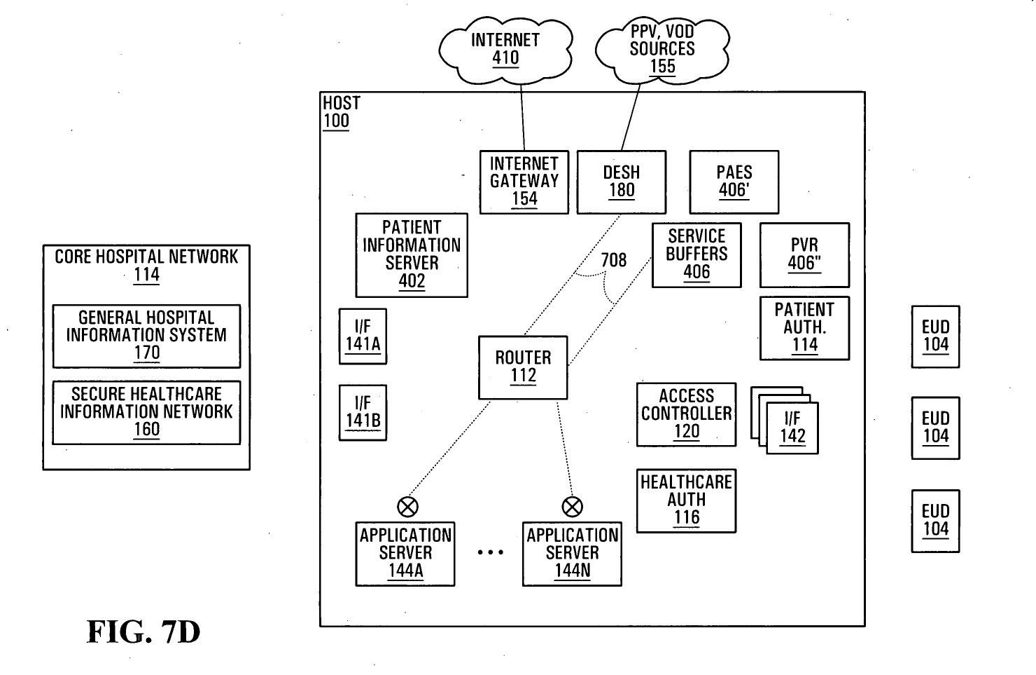

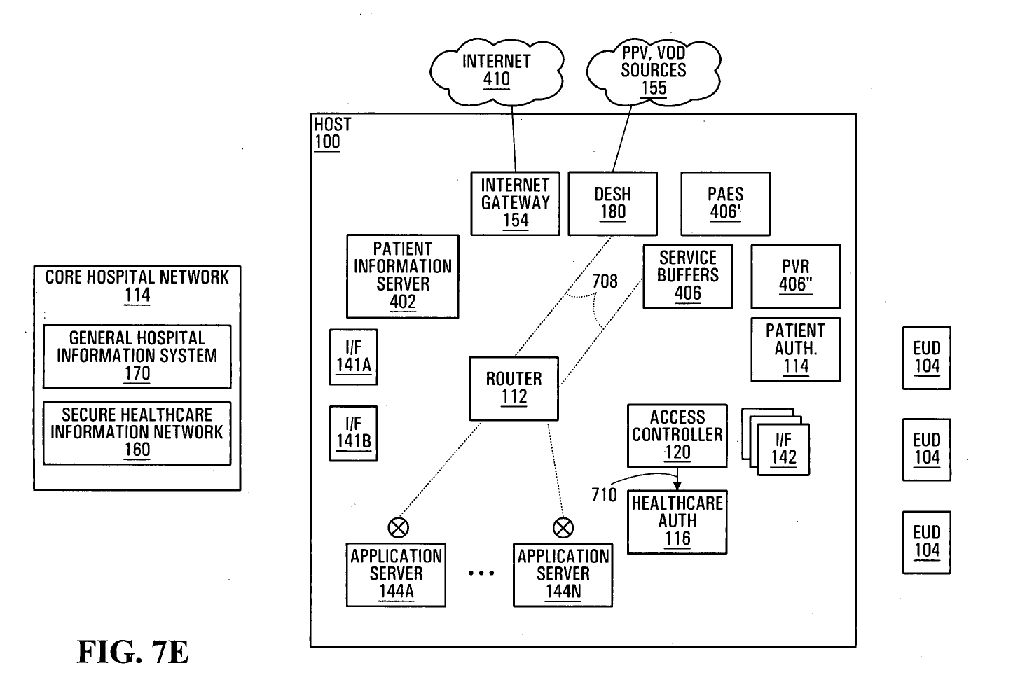

In the event that the non-healthcare user needs to interrupt a PPV or VOD stream (or even optionally the basic TV feed) for whatever reason, then that stream can be diverted via a switching action into the digital video portion of the service buffer 406, which is basically a large multi-functional store. In this case, the service buffer 406 implements the function of a digital personal video recorder (PVR) 406″ which would store the video, up to a certain maximum amount, until the non-healthcare user is ready to resume viewing the material, in which case the PVR 406″ would remain in series with the DESH-patient feed to act as a “time shifter” until the end of that particular program, PPV session or VOD session. Then direct connectivity would be resumed between the digital entertainment services head end 180 and the non-healthcare user. This feature allows a clinician to interrupt a non-healthcare user's viewing experience (e.g., to carry out a series of clinical activities), without costing the non-healthcare user the loss of material that the non-healthcare user has purchased and without causing patient anguish. A more detailed description of interruption of a non-healthcare session is provided later on with reference to FIGS. 7A-7E.

In addition, under control of the non-healthcare authentication entity 114, the non-healthcare user can gain a profiled access to the patient information server 402, which is basically a processor running various applications to permit data access to the general hospital information system 170 (for information/services such as dietary planning) and can gain access to the Internet gateway 154 that will permit the non-healthcare user to browse the web, prepare and send/receive e-mail, etc., on a machine located in the host 100. For added security, non-healthcare users might can be restricted to downloading and/or running applications from the Internet in a secure part of the host 100 (e.g., in the service buffer 406 or the patient information server 402 or another separate firewalled, protected server function, termed the “Patient Application Execution Server” (PAES) 406′), which would have a strong series of defenses against unfriendly software downloaded deliberately or accidentally from the Internet.

As a result the non-healthcare user can have TV, VOD and PPV entertainment, browse the internet, compose or receive e-mails and/or make use of the hospital intranet services via the patient information server 402 in a common integrated, but securely partitioned, infrastructure. Furthermore a secure path can be provided to a VoIP portal off of the hospital PBX or via an Internet-based telephony offering, or by other means permitting telephony service to the non-healthcare user at the bedside. Alternatively, the pre-existing phone system can be retained.

It is noted that since the healthcare data processing resources 106 and/or the non-healthcare data processing resources 108 (or indeed the entire host 100) do not need to be at the point of care, they may be advantageously be kept in a secure location such as a HIS Information Technology Center or even a PBX room, since this provides the epicenter for the telephony wiring. Advantageously, this allows the entire host to be located at a central location which is at the confluence of all the incoming wiring from the terminals throughout the hospital (or at a location easily connected to the confluence of the wiring.)

In a second variant of the host 100, shown in FIG. 4, a common routing entity 112 achieves the dual functionality of routing entities 112A, 112B by using two sets of ports, each used for a separate routing function. Thus, the routing entity 112, which can be a routing complex, is connected to the healthcare authentication entity (CA) 116, the plurality of application servers (AS) 144A, . . . , 144N, the interface (I/F) 141B, the non-healthcare authentication entity (PA) 116, the service buffers 406, the digital entertainment service head end (DESH) 180, the patient information server (PIS) 402, the internet gateway (IGW) 154 and the interface (I/F) 141A. Here, the access controller 120 has direct links to the routing entity 112 in addition to the direct links to the healthcare authentication entity 116 and the non-healthcare authentication entity 114.

Of course, there may be more than just two classes of users requiring mutually exclusive access, in which case additional authentication entities beyond the healthcare authentication entity 116 and the non-healthcare authentication entity 114 can be provided. Generally speaking, the use of separate authentication entities for the purposes of authenticating users belonging to separate user classes has the advantage of preventing scenarios where, by accident or malice, a patient would be authenticated as a clinician, or an orderly would be authenticated as a patient, etc. Such separation prevents AAA messages intended for one AAA server and from that server's clientele from reaching any other AAA server, where it may be misinterpreted as a legitimate message within its service class, resulting in a breach of security. Specifically, this separation is achieved due to operation of the access controller 120, as will now be described in greater detail.

In both variants of FIG. 3 and FIG. 4, it is seen that the access controller 120 communicates with the end user device 104 (via interface 142), as well as with the healthcare authentication entity 116, the non-healthcare authentication entity 114A and the routing entities 112A, 112B (or the single routing entity 112, as appropriate). Generally speaking, the access controller 120 can be said to implement an authentication request message user class verification and routing function. The access controller 120 may be implemented as a computing device having a control entity operative to run application code that controls the extraction, processing and routing of an incoming authentication request message 212 arriving from the end user device 104 via the interface 142. The application code can be downloaded from a secure central site within the host 100 or core hospital network 114 to allow download of access control parameters such as the recognition of the formats used by the message formulator 210 (in the end user device 104) to generate authentication request messages 212 for different user classes.

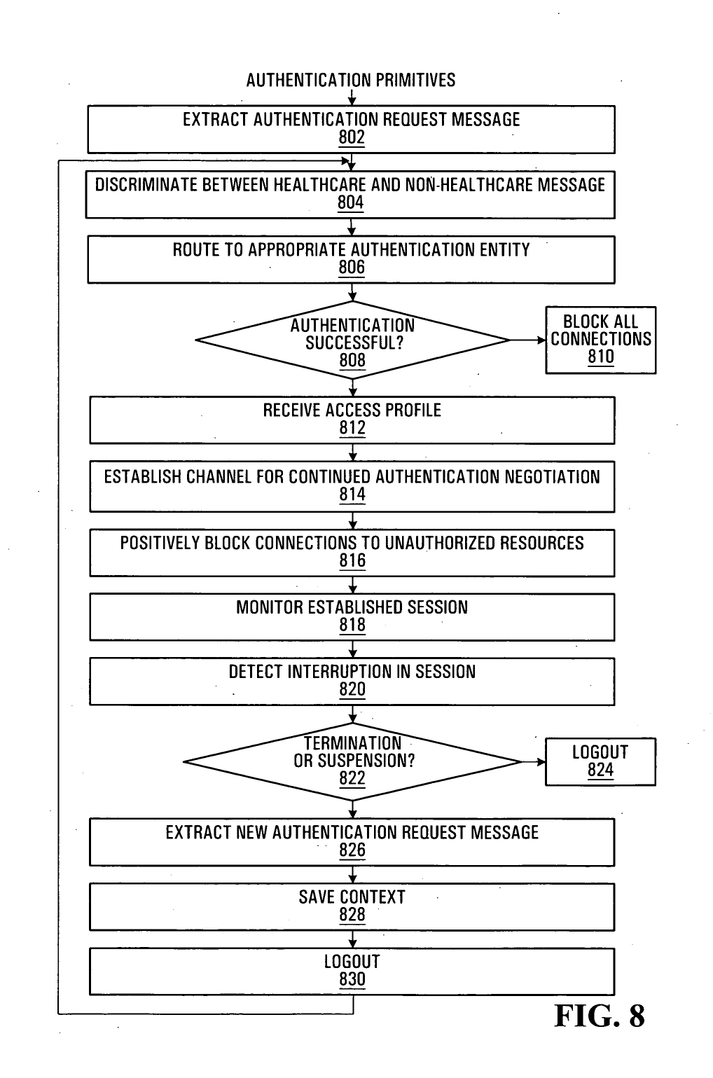

Specifically, with additional reference to the flowchart in FIG. 8, the access controller 120 operates to extract an incoming authentication request message 212 at step 802. Extraction of the incoming authentication request message 212 may be achieved by demultiplexing (e.g. switching out packets based upon their header address) the authentication request message 212 from the signal received from the interface 142. Demultiplexing can be done in hardware or software. Alternatively, extraction of the incoming authentication request message 212 may be achieved by first processing each message received from the interface 142 and then identifying those messages which correspond to an authentication request message 212.

Next, at step 804, the incoming authentication request message 212 is processed on the basis of the fundamentals of how the message has been structured by the message formulator 210 in the end user device 104, in order to identify the authentication entity (in this case either 114 or 116) for which the authentication request message 212 is destined. It is noted that since the authentication request message 212 will be structured differently for the healthcare authentication entity 116 than for the non-healthcare authentication entity 114, this accommodates the typical scenario where the two authentication entities likely originate from differing specialty manufacturers. In an alternative embodiment, the access controller 120 may take over some of the functionality of the message formulator 210, namely the determination of the user class associated with the authentication request message 212, which just as easily allows the access controller 120 to identify the authentication entity for which the authentication request message 212 is destined.

In any event, after having determined the destination authentication entity at step 804, the access controller 120 proceeds to step 806, at which point the authentication request message 212 is routed to the destination authentication entity. Specifically, authentication request messages 212 destined for the healthcare authentication entity 116 are routed to the healthcare authentication entity 116 and authentication request messages 212 destined for the non-healthcare authentication entity 114 are routed to the non-healthcare authentication entity 114. A router or data switch in the access controller 120 can be used for this purpose. The fact that the authentication request message 212 reaches only one of the potential authentication entities eliminates the need to coordinate the healthcare and non-healthcare AAA databases 412, 162 in the core hospital network 114, since neither will be the recipient of stray authentication messages. Thus, because it sends the authentication request message 212 to only one or the other of the authentication entities 116, 114, the access controller 120 prevents either authentication entity from accepting traffic based on a authentication message intended for the other authentication entity which happens to mimic a valid message if received by the wrong entity. It should be understood, however, that the access controller 120 does not override the right of the individual authentication entities to block further traffic from reaching the corresponding set of resources. In fact, the authentication process is carried out independently by the destination authentication entity.

Having delivered the authentication request message to the destination authentication entity, the access controller proceeds to step 808 to await the result of the authentication. If the authentication turns out to be unsuccessful, then the access controller 120 advances to step 810, where the access controller 120 blocks the resources in the host so as to prevent the user from accessing any data in the host 100 or the core hospital network 114. The access controller 120 then returns to a state where it awaits a further authentication request message.

On the other hand, if the authentication turns out to be successful, then the access controller 120 advances to step 812, where it receives an “access profile”, either directly from the routing entity 112 (or 112A or 112B, as appropriate) or via the destination authentication entity (114 or 116, as appropriate). The access profile may include parameters that influence the manner in which the access controller 120 effects its logical processing; for example, it may include time limits on the duration of a session. The access controller 120 then proceeds to step 814, where it optionally establishes a channel for additional authentication negotiations between the destination authentication entity and the end user device 104. These additional authentication negotiations may yield specific limitations on the resources in the set of resources dedicated to the class of users to which the particular user 220 belongs. The end result of these negotiations is the establishment of a session between the end user device 104 and the resources in the host 100. This will be described in greater detail later on in the context of specific examples.

Next, the access controller 120 proceeds to step 816, whereby it initiates a positive block of those resources which the user is definitively excluded from accessing. Specifically, non-healthcare users are excluded from accessing the healthcare resources and healthcare users are excluded from accessing the non-healthcare data processing resources. As will be shown later on in the context of a specific example, the access controller 120 may initiate the positive block by sending a message to all authentication entities other than the destination authentication entity.

After the session has been established between the end user device 104 and the host 100, the access controller 120 monitors the progress of this session at step 818. This may be as simple as being on the lookout for messages received from the end user device 104 (or from deeper within the host 100) that alter the status of a session. Examples of messages that alter the status of a session include but are not limited to messages that interrupt the session (such as messages indicative of session termination and messages indicative of session suspension). Accordingly, it is assumed that at some point throughout the life of the session, the access controller 120 will detect a message indicative of session interruption and this is shown at step 820. The access controller 822 suitably detects if this message belongs to the non-limiting set of messages including messages indicative of session termination and messages indicative of session suspension.

In the case where the message indicative of session interruption is a message indicative of session termination, the access controller 120 proceeds to step 824, where a logout procedure is initiated. In a simple example, this may cause the access controller 120 to notify the destination authentication entity that the end user device 104 no longer needs to access any resources in the host 100 or the core hospital network 114. The end result may be the liberation of a certain amount of bandwidth resources and the finalization of an invoicing procedure.

In the case where the message indicative of session interruption is a message indicative of session suspension, then this may mean that the received message is in fact a new authentication request message, receipt of which is represented at step 826 in FIG. 8. For example, this may arise when a healthcare worker needs to access healthcare resources at a time when a non-healthcare user was using the non-healthcare data processing resources (or vice versa, although the latter may be less common of an occurrence). Accordingly, a logout procedure as described above is performed at step 830, but not before performing a context saving operation at step 828. The context saving operation may take on various forms, such as a rerouting of a live/streamed pay-per-view movie towards the service buffer 406 implementing a PVR 406“(for later, time-shifted” retrieval), or caching of the current state of an e-mail message being composed or caching of the current thread of browser pages being consulted (for later restoration).

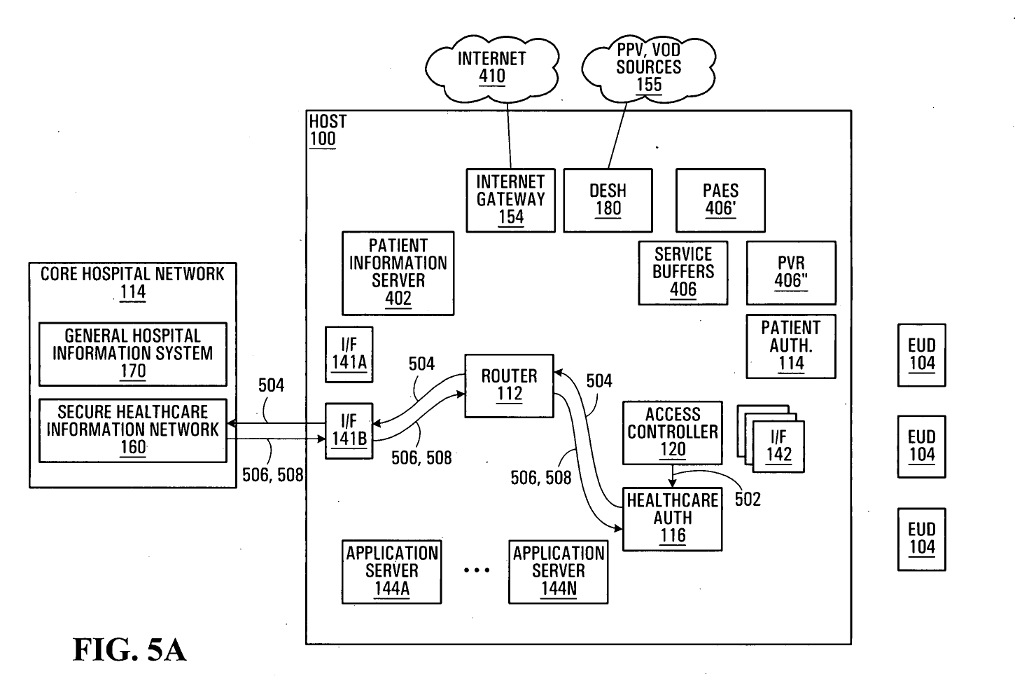

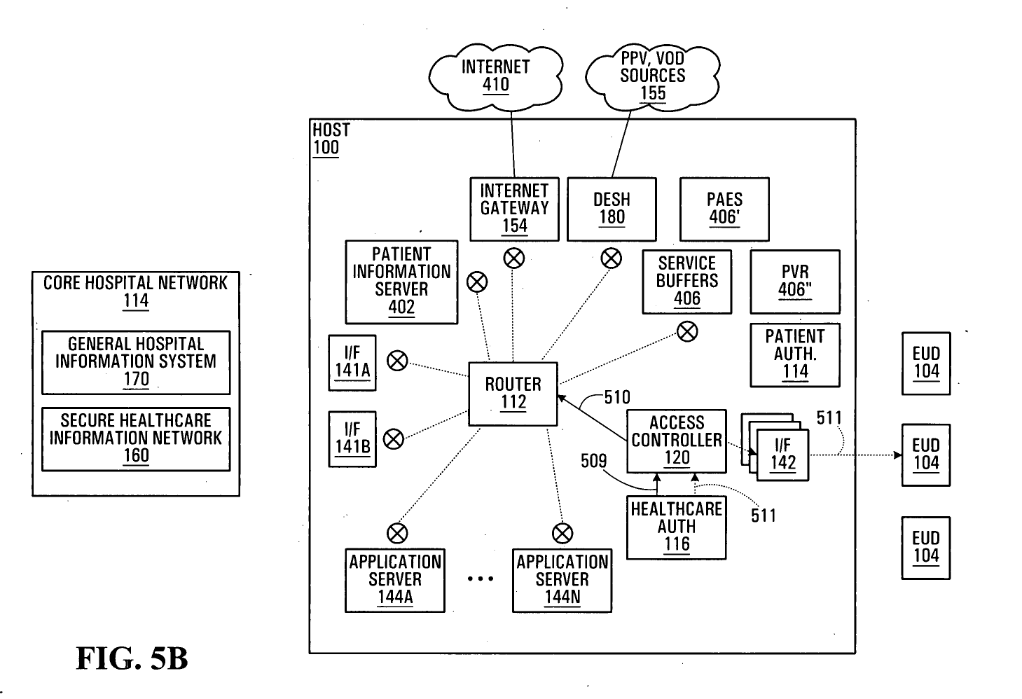

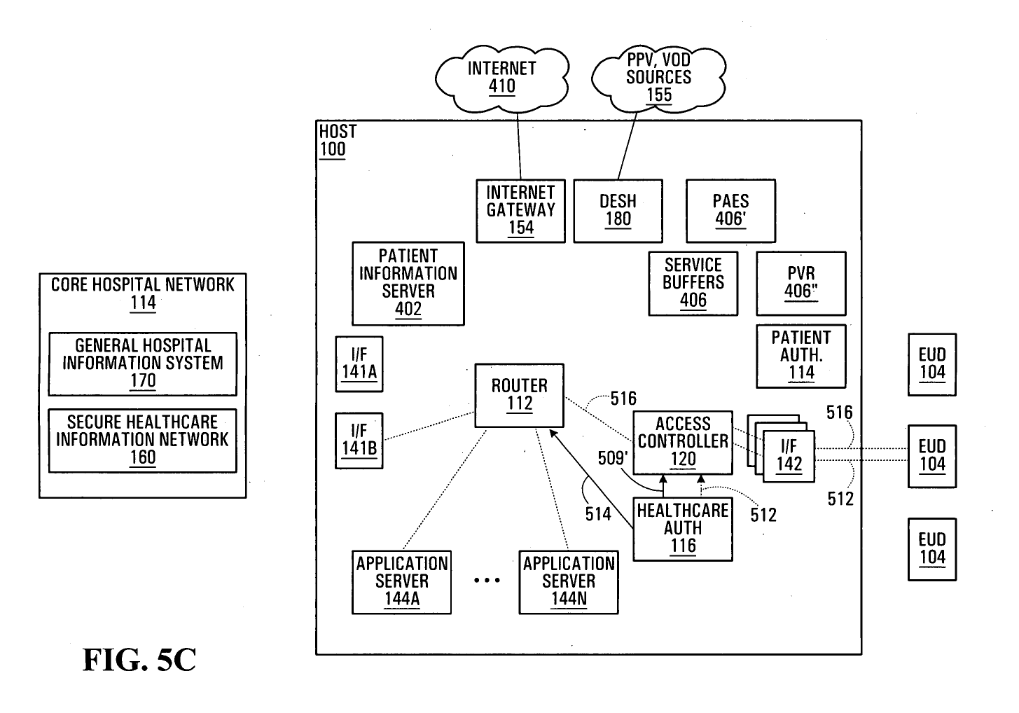

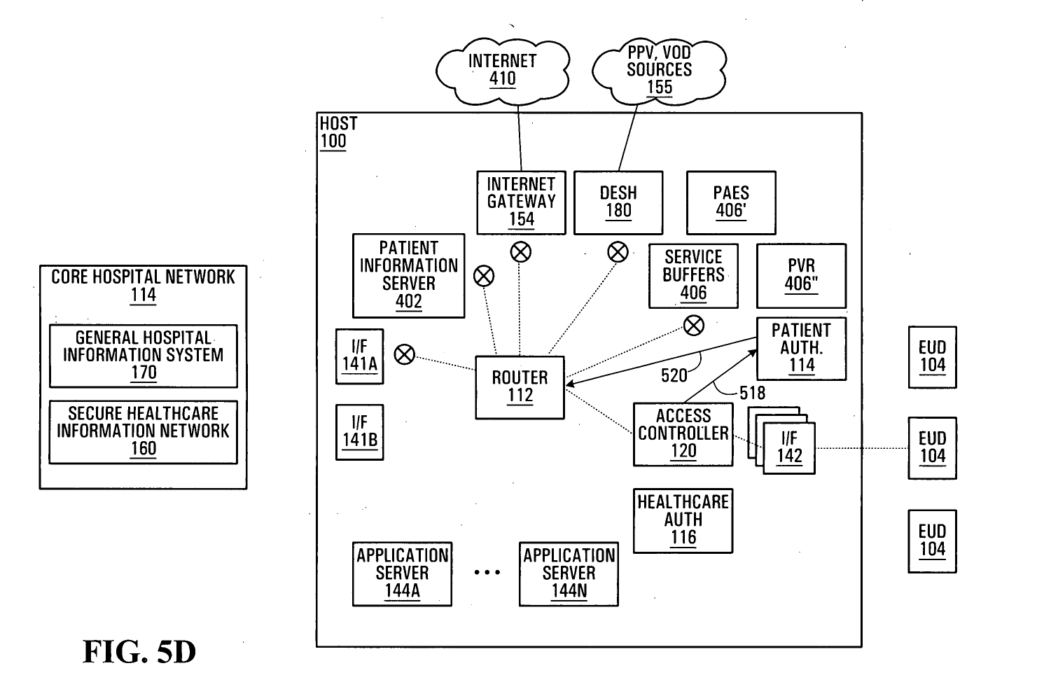

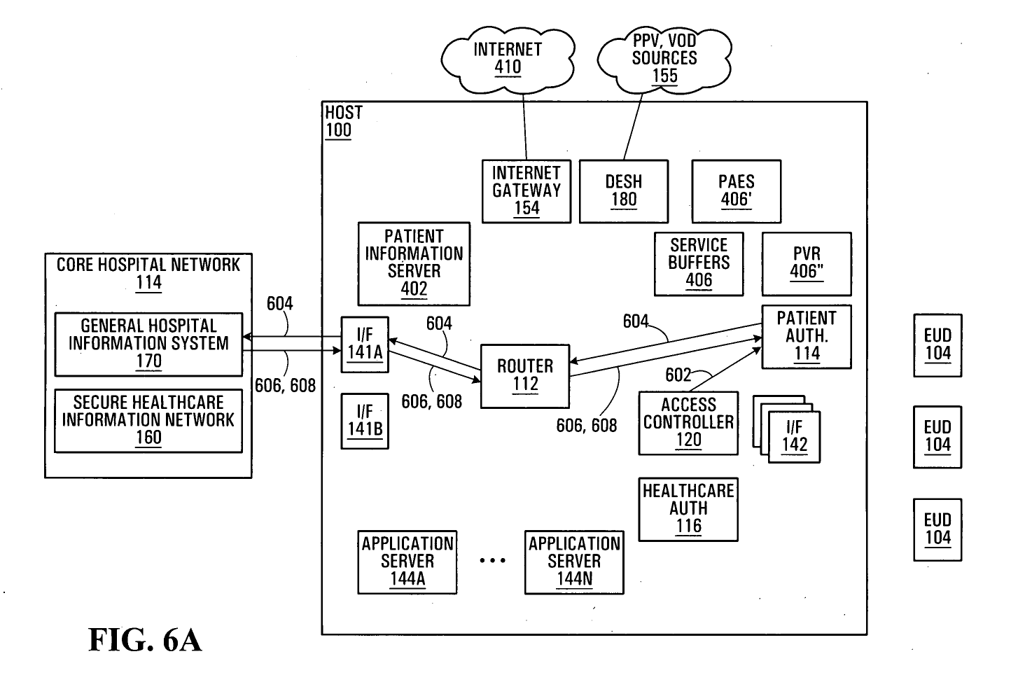

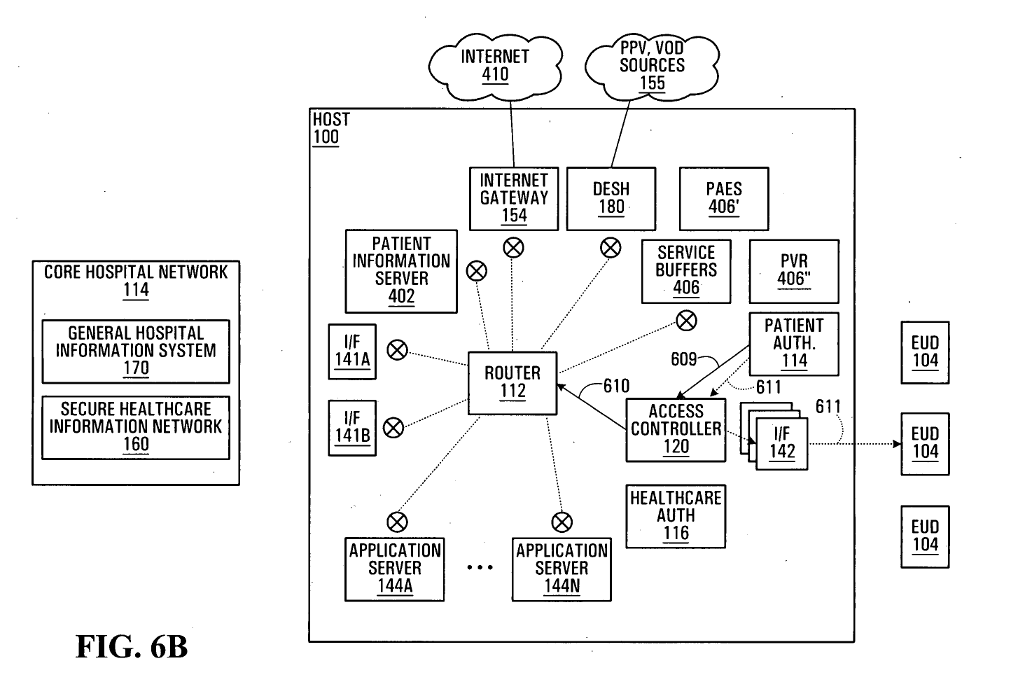

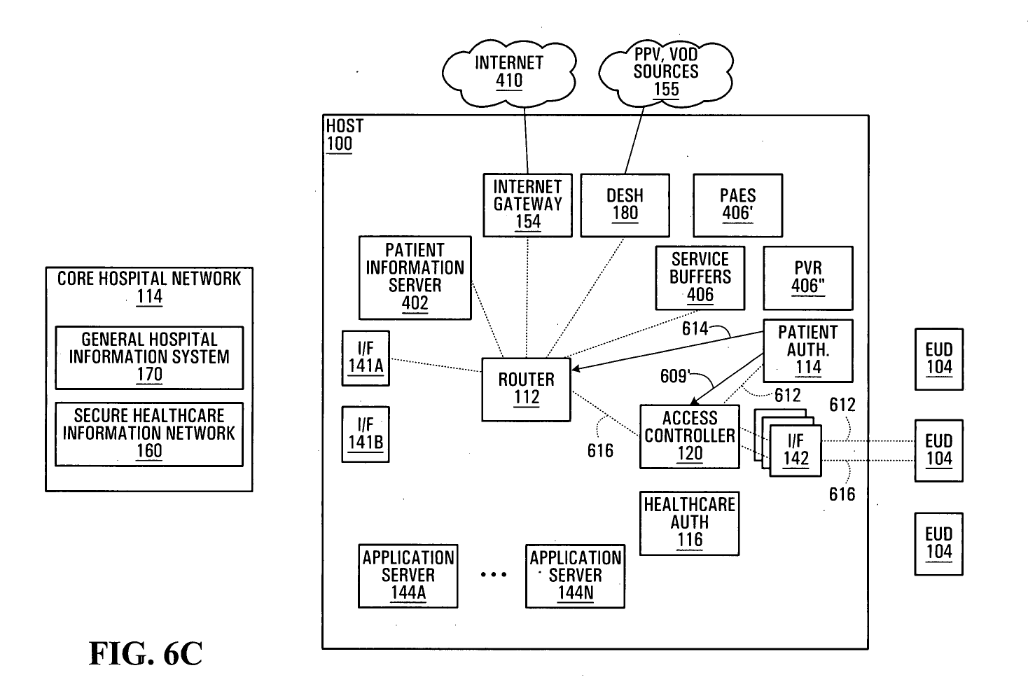

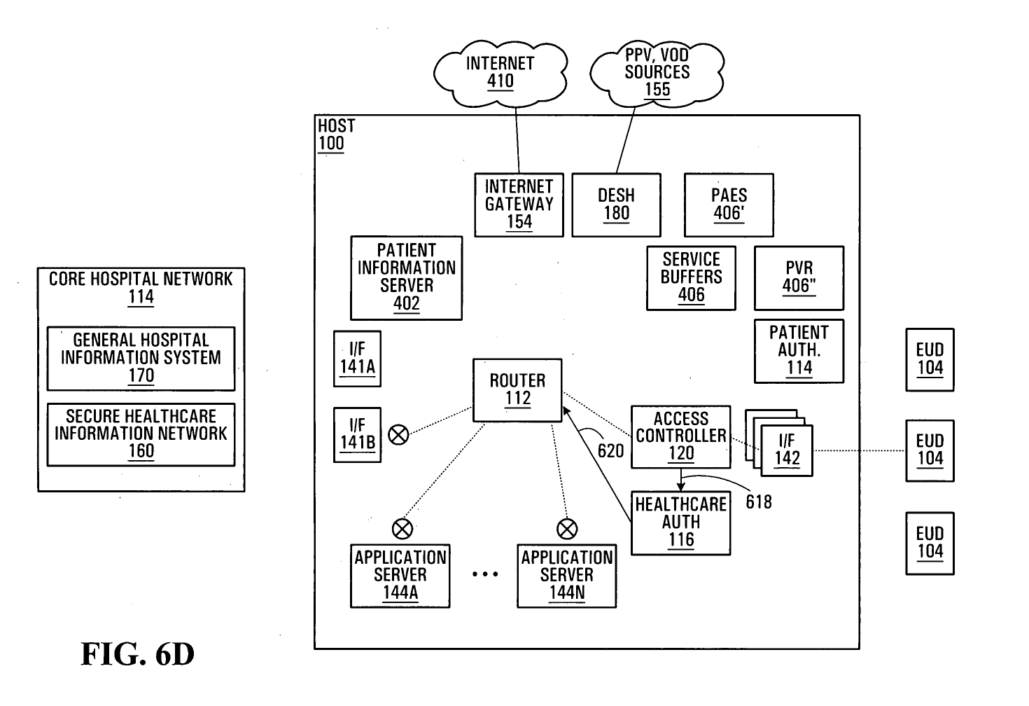

Various examples of the execution of the steps in FIGS. 8 will now be described with reference to FIGS. 5A-5D (for the case where a purported healthcare user is to be authenticated), FIGS. 6A-6D (for the case where a purported non-healthcare user is to be authenticated) and FIGS. 7A-7E (for the case where a non-healthcare session is suspended by a purported healthcare user).

With specific reference to FIGS. 4, 5A and 8, the access controller 120 (at step 802) extracts the authentication request message 212 and (at step 804) determines that the authentication message request is in a valid format for having originated from a healthcare user, based on properties of the authentication request message 212 itself, but not the message information content. The access controller 120 then proceeds to step 806, in order to initiate authentication of the user 220 by the healthcare authentication entity 116. Specifically, the access controller 120 tags the authentication request message 212 with a validity tag and sends a tagged authentication request message 502 to the healthcare authentication entity 116. Depending on the implementation, the access controller 120 may multiplex the tagged authentication request message 502 with other data being sent to the healthcare authentication entity. 116. The access controller 120 then awaits the result of the authentication.

Upon receipt of the tagged authentication request message 502, the healthcare authentication entity 116 performs authentication in one of at least two possible ways. In a first variant, illustrated in FIG. 5A, the healthcare authentication entity 116 sends a query 504 to a server in the secure healthcare information network 160 where the healthcare AAA database 162 is contained, in an attempt to authenticate the user 220. The server in the secure healthcare information network 160 extracts, from the user credentials carried in the tagged authentication request message 502, an indication of who the user 220 is claiming to be (i.e., user identity) in addition to proof (i.e., corroborating evidence) that the user 220 is who he or she is claiming to be. The user identity is used to index the healthcare AAA database 162 which contains stored corroborating evidence for each healthcare user.

If the stored corroborating evidence stored in the healthcare AAA database 162 corresponding to the user identity matches the corroborating evidence supplied by the user 220 by way of the tagged authentication request message 502, then the authentication is said to have been successful. The server in the secure healthcare information network 160 provides the healthcare authentication entity 116 with an indication 506 that the authentication has been successful, in addition to an “access profile” 508 which indicates, e.g., the permissions given to the user 220 with respect to the application servers 144A, . . . , 144N and/or the set of resources in the secure healthcare information network 160. The use of an access profile 508 permits control of the healthcare information and resources being made accessible to different healthcare users. For example, the access profile 508 for a healthcare user who is a clinician or nurse may list the patients forming his or her case load, together with selective permissions for accessing specific levels or areas of information regarding those patients, dependent upon the user's authentication credentials and actual task assignments.

In a second variant (not illustrated), the healthcare authentication entity 116 itself extracts the user identity and the corroborating evidence from the user credentials in the tagged authentication request message 502. The user identity is supplied to the healthcare AAA database 162 in the secure healthcare information network 160, which returns stored corroborating evidence regarding the user identity, as well as the access profile associated with the user 220. The healthcare authentication entity 116 then compares the returned corroborating evidence with the corroborating evidence extracted from the user credentials carried in the tagged authentication request message 502. If there is a match, then the authentication is said to have been successful. These two variants described above result in different partitions of workload and therefore one approach may be preferred over the other, depending on operational requirements. Those skilled in the art will be familiar with yet other variants, each of which is within the scope of the invention.

If the authentication was not successful, and with specific reference to FIG. 5B, the healthcare authentication entity 116 indicates this fact by providing a message 509 to the access controller 120, which now realizes at step 810 that authentication was not successful. Thus, the access controller 120 at step 810 provides a “disable” message 510 to the routing entities 112A, 112B (or 112, as appropriate), for traffic to/from a specific device 104 without affecting the traffic to other devices 104 such as to block the establishment of any connection to any of the resources in the host (including the interfaces 141A, 141B leading to the general hospital information system 170 and the secure healthcare information network 160, respectively). This helps terminate any form of attack. It should be understood, however, that the disable message 510 does not affect the routing operations already under way by the routing entity and/or traffic to/from other end user devices 104. The access controller 120 may also send a message 511 back to the end user device 104, which is indicative of unsuccessful authentication and may lead to the disabling of resources therein.

However, in the event of a successful authentication, and with specific reference to FIG. 5C, the healthcare authentication entity 116 indicates this fact by providing a message 509′ to the access controller 120. The message 509′ received at the access controller 120 (step 812) contains the access profile 508 and causes the access controller 120 to establish (at step 814) a communication flow 512 between the end user device 104 and the healthcare authentication entity 116 in order to allow further authentication negotiations, if necessary, to be carried out. The communication flow 512 may also be used to send to the end user device 104 a command to enable otherwise disabled data processing or storage resources.

The healthcare authentication entity 116 also provides an “enable” signal 514 to the routing entity (1 12B or 112, as appropriate) to allow it to fully connect the end user device 104 to the appropriate application server(s) 144A, . . . , 144N. This results in the establishment of healthcare session over a connection 516 between the end user device 104 at the point of care and the healthcare resources for which the user 220 has been authenticated, e.g., as specified in the access profile 508 returned from the secure healthcare information network 160. This session is monitored by the access controller 120 at step 818. Depending on operational requirements, the connection 516 may take on a variety of forms, non-limiting examples of which include a physical path and a logical connection (virtual path) over a virtual private network (VPN).

Still continuing under the assumption that authentication was successful, and with specific reference to FIG. 5D, the access controller 120 (at step 816) positively blocks connections to unauthorized resources. Specifically, the access controller 120 sends a message 518 to the non-healthcare authentication entity 114 (and any other authentication entities, if applicable), prompting it to keep a positive lock on the non-healthcare data processing resources as regards traffic destined for this particular end user device. For the case where a single routing entity 112 is used (see FIG. 4), the positive lock mechanism is achieved by the non-healthcare authentication entity 114 sending a message 520 to a routing address field enabler in the routing entity 112, which prevents the establishment of a connection using any ports leading to the patient information server 402, digital entertainment services head end 180, Internet gateway 154, service buffers 406 or interface 141 A to this specific end user device. Alternatively, the messages 518 and 520 may be combined into a single message from the access controller 120 to the routing entity 112, provided that the access controller 120 has knowledge of the ports of the routing entity 112 that lead to the patient data processing resources 402, 154, 180, 406, 141A. For the case where separate routing entities 112A, 112B are dedicated to healthcare and non-healthcare functions, respectively (see FIG. 3), the positive lock mechanism is achieved by the access controller 120 itself blocking all further access to the routing entity 112A, which is dedicated to non-healthcare functions. Both variants of the positive lock mechanism provide that, even if the access controller 120 fails, the user 220 will still be blocked from accessing the non-healthcare data processing resources.

The actions which occur in the event that the user identity and the corroborating evidence in the authentication request message 212 identify a non-healthcare user are now described with reference to FIGS. 4 and 6A to 6D. With specific reference to FIGS. 4 and 6A, the access controller 120 extracts the authentication request message 212 at step 802 and, in this case, at step 804, determines that the authentication message request 212 is destined for the non-healthcare authentication entity 114, based on properties of the authentication request message 212 itself, but not the message information content. At step 806, the access controller 120 then proceeds to initiate authentication of the user 220 at the non-healthcare authentication entity 114. The access controller 120 tags the authentication request message 212 with a validity tag and sends a tagged authentication request message 602 to the non-healthcare authentication entity 114. Depending on the implementation, the access controller 120 may multiplex the tagged authentication request message 502 with other data being sent to the non-healthcare authentication entity 114. The access controller 120 then awaits the result of the authentication process.

Upon receipt of the tagged authentication request message 502, the non-healthcare authentication entity 114 performs authentication in one of at least two possible ways. In a first variant, illustrated in FIG. 6A, the non-healthcare authentication entity 114 sends a query 604 to a server in the general hospital information system 170 where the non-healthcare AAA database 412 is contained, in an attempt to authenticate the user 220. The server in the general hospital information system 170 extracts, from the user credentials carried in the tagged authentication request message 602, an indication of who the user 220 is claiming to be (i.e., user identity) in addition to proof (i.e., corroborating evidence) that the user 220 is who he or she is claiming to be. The user identity is used to index the non-healthcare AAA database 412 which contains stored corroborating evidence for each non-healthcare user.

If the stored corroborating evidence stored in the non-healthcare AAA database 412 corresponding to the user identity matches the corroborating evidence supplied by the user 220 by way of the tagged authentication request message 602, then the authentication is said to have been successful. The server in the general hospital information system 170 provides the non-healthcare authentication entity 114 with an indication 606 that the authentication has been successful, in addition to an “access profile” 608 which indicates, e.g., the permissions given to the user 220 with respect to the patient information server 402, Internet gateway 154, digital entertainment services head end 180 and service buffers 406 and/or the set of resources in the general hospital information system 170. The use of an access profile 608 permits control of the non-healthcare information and resources being made accessible to different non-healthcare users. For example, the access profile 608 for a non-healthcare user may include a preferred language of interaction and a list of services for which the user 220 has signed up.

In a second variant (not illustrated), the non-healthcare authentication entity 114 itself extracts the user identity and the corroborating evidence from the user credentials in the tagged authentication request message 602. The user identity is supplied to the non-healthcare AAA database 412 in the general hospital information system 170, which returns stored corroborating evidence regarding the user identity, as well as the access profile associated with the user 220. The non-healthcare authentication entity 114 then compares the returned corroborating evidence with the corroborating evidence extracted from the user credentials carried in the tagged authentication request message 602. If there is a match, then the authentication is said to have been successful. These two variants described above result in different partitions of workload and therefore one approach may be preferred over the other, depending on operational requirements. Those skilled in the art will be familiar with yet other variants, each of which is within the scope of the invention.

If the authentication was not successful, and with specific reference to FIG. 6B, the non-healthcare authentication entity 114 indicates this fact by providing a message 509 to the access controller 120, which now realizes at step 810 that authentication was not successful. Thus, the access controller 120 at step 810 provides a “disable” message 610 to the routing entities 112A, 112B (or 112, as appropriate), such as to prevent the establishment of any connection to any of the resources in the host (including the interfaces 141A, 141B leading to the general hospital information system 170 and the secure healthcare information network 160, respectively) for this specific end user device, thereby terminating any form of attack. It should be understood, however, that the disable message 610 does not affect the routing operations already under way by the routing entity in regard to previously ongoing sessions with other end user devices. The access controller 120 may also send a message 611 back to the end user device 104, which is indicative of unsuccessful authentication and may lead to the issuance of disabling commands by the message formulator 210.

However, in the event of a successful authentication, and with specific reference to FIG. 6C, the non-healthcare authentication entity 114 indicates this fact by providing a message 609′ to the access controller 120. The message 609′ received at the access controller 120 (step 812) contains the access profile 608 and causes the access controller 120 to establish (at step 814) a communication flow 612 between the end user device 104 and the non-healthcare authentication entity 114 in order to allow further authentication negotiations, if necessary, to be carried out. The communication flow 612 may also be used to send to the end user device 104 a command to enable otherwise disabled data processing or storage resources.

The non-healthcare authentication entity 114 also provides an “enable” signal 614 to the routing entity (112A or 112, as appropriate) to allow it to fully connect the end user device 104 to the patient information server 402, Internet gateway 154, digital entertainment services head end 180 and service buffers 406 and/or the set of resources in the general hospital information system 170. This results in the establishment of a non-healthcare session over a connection 616 between the end user device 104 at the point of care and the non-healthcare data processing resources for which the user 220 has been authenticated, e.g., as specified in the access profile 608 returned from the general hospital information system 170. This session is monitored by the access controller 120 at step 818. Depending on the access profile 608, the non-healthcare user may then pursue activities such as surf the Internet, watch a movie via the digital entertainment services head end 180, or access the patient intranet 171 to consult his or her treatment plan or health regimen. Depending on operational requirements, the connection 616 may take on a variety of forms, non-limiting examples of which include a physical path and a logical connection over a virtual private network (VPN).

It is noted that the connection 516 and the connection 616 share the same cabling, and indeed the same infrastructure (for instance, digital carrier and transmission path) between the interface 142 and the end user device 104, with the differentiation being within the addressing or routing of the payloads being delivered. The two paths 516, 616 may occupy the same cabling at mutually exclusive periods of time, allowing one user (be they healthcare or non-healthcare) to access the host processing entity at a given time.

Still continuing under the assumption that authentication was successful, and with specific reference to FIG. 6D, the access controller 120 (at step 816) positively blocks connections to unauthorized resources. Specifically, the access controller 120 sends a message 618 to the healthcare authentication entity 116 (and any other authentication entities, if applicable), prompting it to keep a positive lock on the healthcare resources for that device or VPN. For the case where a single routing entity 112 is used (see FIG. 4), the positive lock mechanism is achieved by the healthcare authentication entity 116 sending a message 620 to the routing address field enabler in the routing entity 112, thereby preventing the establishment of a connection using any ports leading to the application servers 144A, . . . . , 144N or interface 141B. Alternatively, the messages 618 and 620 may be combined into a single message from the access controller 120 to the routing entity 112, provided that the access controller 120 has knowledge of the ports of the routing entity 112 that lead to the healthcare resources 144A, . . . , 144N. For the case where separate routing entities 112A, 112B are dedicated to healthcare and non-healthcare functions, respectively (see FIG. 3), the positive lock mechanism is achieved by the access controller 120 itself blocking all further access to the routing entity 112B, which is dedicated to healthcare functions. Both variants of the positive lock mechanism provide that, in the event of a failure in the access controller 120, the user 220 will still be blocked from accessing the healthcare resources.

It will thus be appreciated how the above described procedure permits a legitimate healthcare or non-healthcare user 220 to access those resources, and only those resources, that the user 220 is truly permitted to access. Since information is prevented from reaching the wrong processing resources, this has the positive effects of improving security, reducing traffic load, improving responsiveness for legitimate users and reducing the probability of a catastrophic outcome from an inadvertent entry from a well-intentioned user who is actually attempting to access the non-healthcare data processing resources.

Once a healthcare session or a non-healthcare session the end user device 104 has been established, the access controller 120 continues to receive messages from the end user device 104 and the host 100. The access controller 120 is designed to monitor the session (step 818) and to be particularly sensitive to messages that indicate an interruption in a session (step 820). This is specifically the case where the message received is indicative of the user 220 having deliberately logged out of his or her session, which causes the access controller 120 to block further access to any of the resources in the host 100 or the core hospital network 114 (see step 824). At this point, the access controller 120 returns to a state where it waits for new authentication request message 212 from the end user device 104. Another type of message indicative of session interruption is a new authentication request message (see step 826) indicative of an attempt by a new user to be authenticated at the end user device 104, before the previous user 220 has logged out of his or her current session. This situation, referred to as a changeover, may arise in various cases, including but not limited to the specific case to be described herein below, where a clinician desires to access healthcare resources at a time when the patient to be treated is watching a movie that he or she has paid for.

With specific reference to FIGS. 7A and 8, a non-healthcare session is assumed to be ongoing over a connection 702 linking the end user device 104 to the digital entertainment services head end 180. Because this is a non-healthcare session, the user 220 will have been blocked from accessing the application servers 144A, . . . , 144N, which are dedicated to healthcare functions. With specific reference to FIG. 7B, the access controller 120 receives, recognizes and extracts a new authentication request message 704 from the end user device 104 (step 826). The new authentication request message 704 is received prior to termination of the non-healthcare session and therefore the access controller 120 initiates a context saving operation (step 828).

With reference now to FIG. 7C, the context saving operation in this case involves the access controller 120 sending a message 706 to the service buffers 406 for the purposes of reserving personal video recorder resources for recording a movie for a particular non-healthcare user. In addition, the routing entity 112 (or 112A, as appropriate) is informed that it should begin routing the movie signal from the digital entertainment services head end 180 to the service buffers 406 instead of towards the end user device 104. Accordingly, as shown in FIG. 7D, routing entity 112 is seen to set up a shunted connection 708 between the digital entertainment services head end 180 and the personal video recorder in the service buffers 406, while continuing to deny access to the application servers 144A, . . . , 144N. This shunted connection 708 remains in existence until the movie is complete. The recorded portions of the movie can be then accessed by the non-healthcare user when the non-healthcare user is re-authenticated at a later time.

Referring specifically now to FIG. 7E, the access controller 120 tags the previously received new authentication request message 704 with a validity tag and sends a tagged authentication request message 710 to the healthcare authentication entity 116. Depending on the implementation, the access controller 120 may multiplex the tagged authentication request message 710 with other data being sent to the healthcare authentication entity 116. Upon receipt of the tagged authentication request message 710, the healthcare authentication entity 116 performs authentication as already described above with reference to FIGS. 5A to 5D. It should be understood that the shunted connection 708 will not be affected by subsequent decisions by the access controller 120 as a result of the authentication process based on the new authentication request message 704.

The above description has assumed the existence of at most one concurrent session for each end user device. If the sessions are established using multiple dedicated VPN's per end user device 104, however, then there is no need to halt a non-healthcare session entirely on one VPN in order to hold a session on the healthcare VPN (provided both can be successfully delivered). While the establishment of concurrent sessions may be more complicated to justify from a security perspective, it nonetheless does lead to a savings of resources as compared to conventional techniques of delivering non-healthcare and healthcare services, since the same cabling and infrastructure is reused for the delivery of both types of services. Thus, it should be understood that when the connections 516, 616 are logical connections, they may occupy the same cabling contemporaneously, while also employing the same digital carrier.

While specific embodiments of the present invention have been described and illustrated, it will be apparent to those skilled in the art that numerous modifications and variations can be made without departing from the scope of the invention as defined in the appended claims.

1. An architecture for delivery of communications services within a hospital, comprising:
a set of healthcare data processing resources for providing healthcare communications services to users at a plurality of delivery points throughout the hospital;
a set of non-healthcare data processing resources for providing non-healthcare communications services to the users at the plurality of delivery points;
a data routing entity connected to the healthcare data processing resources and to the non-healthcare data processing resources;
a common access infrastructure connected between the data routing entity and the plurality of delivery points, for supporting both the healthcare communications services and the non-healthcare communications services;
the data routing entity being operative to control access by the users at the plurality of delivery points to the healthcare data processing resources and to the non-healthcare data processing resources.

2. The architecture defined in claim 1, wherein the healthcare communications services and the non-healthcare communications services delivered to a common one of the delivery points occupy the common access infrastructure during mutually exclusive periods of time.

3. The architecture defined in claim 1, wherein the healthcare communications services and the non-healthcare communications services delivered to a common one of the delivery points occupy the common access infrastructure contemporaneously.

4. The architecture defined in claim 3, wherein the healthcare communications services and the non-healthcare communications services delivered to a common one of the plurality of delivery points are delivered over distinct logical connections sharing the common access infrastructure.

5. The architecture defined in claim 1, wherein, at a given time instant, healthcare communications services are being delivered to a first subset of the plurality of delivery points while non-healthcare communications services are being delivered to a second subset of the plurality of delivery points.

6. The architecture defined in claim 1, wherein the healthcare data processing resources comprise a plurality of healthcare application servers for running clinical software.

7. The architecture defined in claim 6, wherein the healthcare communications services comprise a computerized physician order entry service.

8. The architecture defined in claim 1, wherein the healthcare data processing resources comprise a healthcare authentication entity for authenticating users at the delivery points claiming to be healthcare users.

9. The architecture defined in claim 8, wherein the non-healthcare data processing resources comprise a non-healthcare authentication entity for authenticating users of the delivery points claiming to be non-healthcare users.

10. The architecture of claim 9, the data routing entity further comprising an access controller operative to:
receive an authentication request message comprising user credentials and a user class regarding a user at a given one of the plurality of delivery points;
determine, based on the user class, a destination authentication entity from between the healthcare authentication and the non-healthcare authentication entity;
release the user credentials towards the destination authentication entity for authentication of the user.

11. The architecture defined in claim 10, the access controller further operative to receive from the destination authentication entity an indication of successful or unsuccessful authentication of the user by the destination authentication entity.

12. The architecture defined in claim 11, the access controller being further operative to respond to successful authentication of the user by the destination authentication entity by causing establishment of a connection for the delivery of a healthcare communications service from the healthcare data processing resources or a non-healthcare communications service from the non-healthcare data processing resources, in dependence upon the user class corresponding to the user.

13. The architecture defined in claim 11, wherein the user class corresponding to the user belongs to a set comprising at least a healthcare user class and a non-healthcare user class.

14. The architecture defined in claim 13, the access controller being further operative to respond to successful authentication of the user by the destination authentication entity by causing establishment of a connection for the delivery of either a healthcare communications service if the user is determined to belong to the healthcare user class, or a non-healthcare communications service if the user is determined to belong to the non-healthcare user class.

15. The architecture defined in claim 14, the data routing entity further comprising a switching entity operative to route the authentication request message to the access controller.

16. The architecture defined in claim 15, the data routing entity further comprising a second switching entity for selective establishment of connections between the delivery point and either the healthcare data processing resources or the non-healthcare data processing resources.

17. The architecture defined in claim 16, the access controller being further operative to respond to successful authentication of the user by the destination authentication entity by providing an indication of said successful authentication of the user by the destination authentication entity to a second one of the authentication entities other than the destination authentication entity.

18. The architecture defined in claim 17, the second authentication entity being operative to prevent establishment of a connection for the exchange of data between the delivery point and a subset of the data processing resources other than the subset of the data processing resources with which a connection has been established.

19. The architecture defined in claim 18, wherein the second authentication entity being operative to prevent establishment of a connection comprises the second authentication entity causing the second switching entity to deny any connections therethrough which would allow establishment a connection between the end user device and said subset of the data processing resources other than the subset of the data processing resources with which a connection has been established.

20. The architecture defined in claim 1, wherein the non-healthcare data processing resources comprise a digital entertainment head end for controlling delivery to the delivery points of received digital entertainment services.

21. The architecture defined in claim 20, wherein the non-healthcare communications services comprise patient entertainment services.

22. The architecture defined in claim 21, wherein the non-healthcare communications services comprise personal video recorder services.

23. The architecture defined in claim 1, wherein the non-healthcare data processing resources comprise an Internet gateway.

24. The architecture defined in claim 1, wherein the non-healthcare data processing resources comprise a patient information server for allowing access to patient information services.

25. The architecture defined in claim 1, wherein the data routing entity is operative to permit delivery of non-healthcare communications services to a first one of the delivery points in response to successful authentication of a user at said first delivery point claiming to be a non-healthcare user.

26. The architecture defined in claim 1, wherein the data routing entity is operative to permit delivery of healthcare communications services to a first one of the delivery points in response to successful authentication of a user at said first delivery point claiming to be a healthcare user.

27. The architecture defined in claim 26, wherein the data routing entity is operative to permit delivery of non-healthcare communications services to said first delivery point in response to successful authentication of a user at said first delivery point claiming to be a non-healthcare user.

28. The architecture defined in claim 27, wherein a healthcare user is defined as a user who is a physician, a nurse or an orderly.

29. The architecture defined in claim 28, wherein a non-healthcare user is defined as a user who is an admitted patient or a visitor.

30. The architecture defined in claim 1, wherein the access infrastructure comprises a partly wireless infrastructure.

31. The architecture defined in claim 1, wherein the access infrastructure comprises a fixed-wire cabling infrastructure.

32. The architecture defined in claim 1, wherein the fixed-wire cabling infrastructure comprises point-to-point telephony wiring.

33. The architecture defined in claim 31, wherein the cabling infrastructure includes a twisted pair wiring base.

34. The architecture defined in claim 33, wherein said twisted pair wiring base comprises PBX access-side twisted pair.

35. The architecture defined in claim 33, wherein said twisted pair wiring base comprises Cat 2-3 twisted pair.

36. The architecture defined in claim 33, wherein said twisted pair wiring base comprises Cat 5 twisted pair.

37. The architecture defined in claim 1, further comprising:
a telephony head end connected to the access infrastructure and operative to exchange telephony signals via the access infrastructure used to support both the healthcare communications services and the non-healthcare communications services.

38. The architecture defined in claim 37, wherein the telephony signals are digital telephony signals.

39. The architecture defined in claim 38, wherein the telephony signals occupy a first frequency range and wherein the healthcare communications services and the non-healthcare communications services occupy a second frequency range different from the first frequency range.

40. The architecture defined in claim 39, wherein the first frequency range is lower than the first frequency range.

41. The architecture defined in claim 37, wherein the telephony signals are baseband analog telephony signals.

42. An access controller for use in authenticating users of a network, the access controller comprising:
an input operative to receive an authentication request message indicative of user credentials and a user class regarding a user of an end user device;
a control entity operative to determine, based on the user class, a destination authentication entity from among a plurality of authentication entities;
an output operative to release the user credentials towards the destination authentication entity for authentication of the user.

43. The access controller defined in claim 42, further comprising a second input operative to receive from the destination authentication entity an indication of successful or unsuccessful authentication of the user by the destination authentication entity.

44. The access controller defined in claim 43, the control entity being further operative to respond to successful authentication of the user by the destination authentication entity by causing establishment of a connection for the exchange of data between the end user device and a subset of the data processing resources.

45. The access controller defined in claim 44, the second input further operative to receive from the destination authentication entity an access profile indicative of the subset of the data processing resources.

46. The access controller defined in claim 45, the control entity being further operative to respond to successful authentication of the user by the destination authentication entity by preventing establishment of a connection for the exchange of data between the end user device and a predetermined second subset of the data processing resources.

47. The access controller defined in claim 42, wherein the user class corresponding to the user belongs to a set comprising at least a healthcare user class and a non-healthcare user class.

48. A host processing entity for use in allowing users to access data processing resources in a hospital, the host processing entity comprising:
a plurality of authentication entities for authenticating users belonging to respective user classes;
an access controller operative to:
receive an authentication request message comprising user credentials and a user class regarding a user at an end user device;
determine, based on the user class, a destination authentication entity from among the plurality of authentication entities;
release the user credentials towards the destination authentication entity for authentication of the user.

49. The host processing entity defined in claim 48, the access controller further operative to receive from the destination authentication entity an indication of successful or unsuccessful authentication of the user by the destination authentication entity.

50. The host processing entity defined in claim 49, the access controller being further operative to respond to successful authentication of the user by the destination authentication entity by causing establishment of a connection for the exchange of data between the end user device and a subset of the data processing resources.

51. The host processing entity defined in claim 50, the access controller being further operative to receive from the destination authentication entity an access profile indicative of the subset of the data processing resources.

52. The host processing entity defined in claim 51, further comprising a switching entity operative to establish the connection between the end user device and the subset of the data processing resources.

53. The host processing entity defined in claim 51, the access controller being further operative to respond to successful authentication of the user by the destination authentication entity by providing an indication of said successful authentication of the user by the destination authentication entity to a second one of the authentication entities other than the destination authentication entity.

54. The host processing entity defined in claim 53, the second authentication entity being operative to prevent establishment of a connection for the exchange of data between the end user device and a second subset of the data processing resources other than the first subset of the data processing resources.

55. The host processing entity defined in claim 54, further comprising a switching entity operative to establish the connection between the end user device and the first subset of the data processing resources.

56. The host processing entity defined in claim 55, wherein the second authentication entity being operative to prevent establishment of a connection comprises the second authentication entity causing the switching entity to deny any connections therethrough which would allow establishment a connection between the end user device and the second subset of the data processing resources.

57. The host processing entity defined in claim 48, wherein the user class corresponding to the user belongs to a set comprising at least a healthcare user class and a non-healthcare user class.

58. A method of controlling user access to resources in a data network, the method comprising:
receiving an authentication request message comprising user credentials and a user class regarding a user at an end user device;
determining, based on the user class, a destination authentication entity from among a plurality of authentication entities;
releasing the user credentials towards the destination authentication entity for authentication of the user.

59. The method defined in claim 58, further comprising:
receiving from the destination authentication entity an indication of successful or unsuccessful authentication of the user by the destination authentication entity.

60. The method defined in claim 59, further comprising:
responsive to successful authentication of the user by the destination authentication entity, enabling the user to access a subset of the resources in the data network that depends on the user class corresponding to the user.

61. The method defined in claim 60, the subset of the resources in the data network being a first subset of the resources in the data network, the method further comprising:
responsive to successful authentication of the user by the destination authentication entity, disabling the user from accessing a second subset of the resources in the data network that depends on the user class corresponding to the user.

62. The method defined in claim 61, wherein the user class corresponding to the user belongs to a set comprising at least a healthcare user class and a non-healthcare user class.

63. The method defined in claim 62, wherein the first subset of the resources in the data network comprises patient entertainment and information systems when the user class corresponding to the user is the non-healthcare user class.

64. The method defined in claim 63, wherein the first subset of the resources in the data network comprises healthcare application servers when the user class corresponding to the user is the healthcare user class.

65. The method defined in claim 60, further comprising:
receiving from the destination authentication entity an indication of the first subset of the resources in the data network.

66. The method defined in claim 65, wherein enabling the user to access the first subset of the resources in the data network comprises enabling the establishment of a session between the remote entity and the first subset of the resources in the data network.

67. The method defined in claim 66, further comprising, in the case of successful authentication of the user by the destination authentication entity:
receiving from the destination authentication entity an indication of the second set of the resources in the data network.

68. The method defined in claim 67, wherein disabling the user from accessing the second subset of the resources in the data network comprises disabling the establishment of a session between the remote entity and the second subset of the resources in the data network.

69. The method defined in claim 66, further comprising, in the case of successful authentication of the user by the destination authentication entity:
providing an indication of said successful authentication of the user by the destination authentication entity to an authentication entity other than the destination authentication entity.

70. The method defined in claim 69, further comprising:
receiving from said authentication entity other than the destination authentication entity an indication of the second set of the resources in the data network.

71. The method defined in claim 66, wherein the first and second subsets of the resources in the data network each comprise respective interfaces of a data switching entity.

72. The method defined in claim 71, wherein said interfaces comprise physical ports of the data switching entity.

73. The method defined in claim 71, wherein said interfaces comprise logical connections through the data switching entity.

74. The method defined in claim 48, wherein releasing the user credentials towards the destination authentication entity comprises not releasing the user credentials towards any authentication entity other than the destination authentication entity.

75. The method defined in claim 48, further comprising:
responsive to successful authentication of the user by the destination authentication entity, providing a command to enable a set of resources in the end user device.

76. The method defined in claim 48, further comprising:
responsive to unsuccessful authentication of the user by the destination authentication entity, providing a command to disable a set of resources in the end user device.

77. The method defined in claim 56, the session being a first session, the destination authentication entity being the first authentication entity, the method further comprising:
during the first session, receiving a second authentication request message indicative of second user credentials and a second user class regarding a second user at the end user device;
determining, based on the second user class, a second destination authentication entity from among the plurality of authentication entities;
releasing the second user credentials towards the second destination authentication entity for authentication of the second user.

78. The method defined in claim 77, further comprising:
suspending the first session.

79. The method defined in claim 78, wherein suspending the first session is performed prior to determining the second destination authentication entity.

80. The method defined in claim 79, wherein suspending the first session comprises:
if the first session corresponds to delivery of a video stream to the remote device, routing the video stream to a personal video recorder for future access by the first user.

81. The method defined in claim 79, wherein suspending the first session comprises:
if the first session corresponds to an electronic mail application, saving a context of the electronic mail application for future retrieval by the first user.

82. Computer-readable media tangibly embodying a program element for execution by a computing device to implement an access controller, said access controller including:
an interface entity operative to receive an authentication request message indicative of user credentials and a user class regarding a user at an end user device;
a control entity operative to determine, based on the user class, a destination authentication entity from among a plurality of authentication entities;
the interface further operative to release the user credentials towards the destination authentication entity for authentication of the user.

83. An access controller for controlling user access to resources in a data network, comprising:
means for receiving an authentication request message indicative of user credentials and a user class regarding a user at an end user device;
means for determining, based on the user class, a destination authentication entity from among a plurality of authentication entities;
means for releasing the user credentials towards the destination authentication entity for authentication of the user.

84. A method of formulating an authentication request message, comprising:
receiving authentication primitives from an end user, the authentication primitives being indicative of a user class and user credentials regarding a user;
determining the user class from the authentication primitives;
creating an authentication request message from the authentication primitives, the authentication request message containing data indicative of at least the user credentials and being in a format that is dependent upon the user class;
outputting the authentication request message.

85. The method defined in claim 84, further comprising:
validating the authentication primitives to determine compliance with a predetermined format;
wherein creating is conditional upon the authentication primitives complying with the predetermined format.

86. The method defined in claim 85, wherein the predetermined format comprises a first portion that encodes the user class.

87. The method defined in claim 86, wherein the predetermined format comprises a second portion that encodes user credentials comprising a user identity and corroborating evidence.

88. The method defined in claim 87, wherein said first portion comprises data supplied by a bar code reader or magnetic card reader.

89. The method defined in claim 87, wherein said first portion and said user identity comprises data supplied by a bar code reader or magnetic card reader.

90. The method defined in claim 87, wherein the corroborating evidence comprises biometric data obtained from the user.

91. The method defined in claim 87, wherein the user identity comprises a user name and wherein the corroborating evidence comprises a personal identification code.

92. An end user device, comprising:
an input device operative to receive authentication primitives from an end user, the authentication primitives being indicative of a user class and user credentials regarding a user;
a message formulator, operative to determine the user class from the authentication primitives and to create an authentication request message from the authentication primitives, the authentication request message containing data indicative of at least the user credentials and being in a format that is dependent upon the user class;
an output for releasing the authentication request message.

93. The end user device defined in claim 92, wherein the input device comprises an authentication device.

94. The end user device defined in claim 93, wherein the authentication device comprises at least one of a bar code scanner, a biometric reader, a magnetic card reader and a radio frequency badge reader.

95. The end user device defined in claim 92, further comprising a main processor that is capable of receiving data from the message formulator and prevented from sending data to the message formulator.
